(19) United States
(12) Patent Application Publication
(10) Pub. No.: US 2004/0246531 A1
(43) Pub. Date: Dec. 9, 2004

(54) Server device having electronic bulletin board function

(75) Inventors: Masashi Eguchi, Joyo-shi (JP); Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/844,444

(22) Filed: May 13, 2004

(30) Foreign Application Priority Data
Jun. 3, 2003 (JP) 2003-157856
Jun. 3, 2003 (JP) 2003-158056
Jun. 20, 2003 (JP) 2003-175713

(51) Int. Cl. H04N 1/00

(52) U.S. Cl. 358/400

(57) ABSTRACT

When a user clicks and references a title from titles displayed in a thread on an electronic bulletin board, a control unit instructs an electronic bulletin board information generating unit to generate electronic bulletin board information including a main text and an image of a comment and transmits the electronic bulletin board information to a user terminal. When the user sends a reply of a new image or an edited image, identification information is provided to the transmitted image and the image is stored in an image storage unit. In addition, link information that links the image to the original image is transmitted to an image data version information management unit. In this case, when there is no reply of a comment, the control unit instructs an automatic comment generating unit to generate a comment of a reply of the new image or the edited image. The comment is stored in a comment storage unit and the comment link information is transmitted to a comment link information management unit.

### BACKGROUND OF THE INVENTION

1. Field of the Invention

The present invention relates to a server device having an electronic bulletin board function accessed by a plurality of users via a communication network for information to be exchanged by each of the users. The present invention also relates to a document management server device having a plurality of applications such as an electronic bulletin board function, and a document forwarding method for forwarding a document between each of the applications in the document management server device.

2. Description of the Related Art

An electronic bulletin board written and retrieved by a plurality of users is widely used for transmitting various pieces of information in a company or for carrying out communication between a company or a local government and the general public. For example, the electronic bulletin board is used in a public square of various events or for introducing a new product. When using the electronic bulletin board in a company, a reference prepared for a meeting can be distributed and various announcements can be made over a system known as the electronic bulletin board. In particular, the electronic bulletin board is especially suitable for requesting work in a company and grasping results of the work, managing a related reference and publishing a situation of the work and the reference.

Such an electronic bulletin board function is implemented by a system that includes a server device which stores information to be placed on an electronic bulletin board. In the electronic bulletin board system, newly registered electronic bulletin board information is transmitted from a user terminal via a communication network to the server device. The new electronic bulletin board information received by the server device is stored in a database. Then, the new electronic bulletin board information is added to registered electronic bulletin board information and transmitted to the user terminal via the communication network. The new electronic bulletin board information is displayed on a screen of the user terminal.

Meanwhile, in the electronic bulletin board system, there is an electronic bulletin board that can post text information of a comment and also image information of a picture or the like. In particular, in case a facsimile system is provided with the electronic bulletin board function, an image received by facsimile or an image scanned by a scanner is posted on the electronic bulletin board. Further, in the facsimile system, a facsimile server or a digital multifunction peripheral is connected to a client device such as a personal computer via a Local Area Network (LAN). The facsimile server is connected to a communication line such as a Public Switched Telephone Network (PSTN) and includes a facsimile transmitting and receiving function. The digital multifunction peripheral includes a copy function, a facsimile function, a print function, a scanner function or the like.

In the above-described electronic bulletin board that can also post an image, there are cases in which an attached image is a more important piece of information than a content of the comment. For example, when exchanging a drawing of a product via the electronic bulletin board in a product developing section of a company, or when circulating an order slip between operation divisions of a company via the electronic bulletin board, there are many cases in which the image information is a more important piece of information than the comment. For many cases, a user just edits the image by filling a marker in the image or attaching a label image or the like, and then sends a reply.

However, in the conventional electronic bulletin board, a text is used mainly and an image is used only supplementarily. Therefore, a presence or an absence of an image cannot be grasped promptly or an image cannot be processed promptly. For example, in the conventional electronic bulletin board, a thread of titles of comments is displayed on a display screen. However, from the thread display screen, a determination cannot be made as to whether or not an image is attached to each of the comments. Since an image attached to a comment cannot be accessed unless referencing each of the comments, there was a drawback that the operation is time consuming.

As described above, when the user edits an image without editing a comment and sends a reply, a title, which “RE:” is attached to the original title, is simply displayed in the thread display list of the titles of the comments. Therefore, when a next user looks at the thread display list, the user cannot confirm whether or not the image has been edited. The user is required to reference all documents in the thread from original documents of the thread.

In the conventional electronic bulletin board, a thread of the titles of the comments is displayed on the display screen. However, when attempting to look at an image in each thread, the image cannot be viewed unless referencing each of the comments. Therefore, all of the images in the thread cannot be displayed at once. Furthermore, when reading main text of the comment, the main text cannot be read unless referencing each of the comments. As a result, a long period of time is required for viewing all of the images and the comments.

When saving, printing or transmitting to someone, an image or text information attached to a specific thread or a comment, it is necessary to reference and display each of the comments and then to save or print each of the comments. In particular, when it is necessary to save or print all of images and text information in a thread, it is necessary to carry out saving or printing process for each of the images and the text information, respectively. There was a drawback that the operation is extremely time consuming.

As described above, in the conventional document management server device, there are cases in which the image received by facsimile or the image scanned by the scanner is posted on the electronic bulletin board. When forwarding the facsimile image or the scanner image to the electronic bulletin board server, an electronic bulletin board is displayed, and a new registration or a comment is designated and a reply is selected from the display screen of the electronic bulletin board. In addition, after selecting a forwarding image from an image file, a comment is entered or a category is designated and then the image is forwarded. As a result, a long period of time is required for forwarding an image to the electronic bulletin board.

### SUMMARY OF THE INVENTION

The present invention was made in view of the above-described circumstances. An advantage of the present invention is to provide a server device having an electronic bulletin board function that can handle an image and a text in the same manner without handling the image supplementarily and that is suitable for a system using a digital multifunction peripheral or a scanner.

Another advantage of the present invention is to provide a document management server device and a document forwarding method that can simplify an operation for forwarding a document from an application to another application in a server device, e.g., when forwarding a facsimile image or a scanner image to an electronic bulletin board server.

According to an aspect of the present invention, when there is a only a reply indicating that an image has been edited or a reply indicating that a new image has been registered, the server device having the electronic bulletin board function automatically generates a comment indicating such a fact. Therefore, a user who looks at the electronic bulletin board thereafter can easily confirm that an image has been edited or a new image has been registered.

When an image has been edited or a new image has been registered, the image or an image icon as shortcut information is displayed on the electronic bulletin board. Therefore, the user can easily display the image.

The server device having the electronic bulletin board function includes an image data version management unit that manages a version of an image attached to a comment. For example, when an image is edited, an image of only the edited content (differential data) can be stored. A storage capacity of the image can be reduced. In addition, an original image and the edited image can be combined in accordance with the version information and a necessary image can be displayed immediately.

Furthermore, a thumbnail list of all images included in the selected thread can be displayed on the electronic bulletin board. Among the images displayed in the list, by focusing on an original image of the selected thread, the image can be recognized easily and the original image of the thread can also be recognized easily.

According to the present invention, the server device having the electronic bulletin board function includes a composing unit that composes image data or text data attached to a specific thread or comment. Therefore, the server device can form a composite file by randomly selecting only image data, only text data or a mixture of the data from the image data or the text data attached to a specific thread or comment and composing the selected data. The image or the text data attached to the specific thread or comment can be restructured into one document, and the document can be displayed, saved, printed, transmitted, etc.

If the file composing unit composes a file by converting text data into an image under a designated font, a user can use a desired font. By using the file composed by the file composing unit, only the image data, the text data or a mixture of the data can be selected randomly from the image data or the text data attached to the specific thread or comment, and the selected data can be displayed in a thumbnail list on the electronic bulletin board. As a result, the image data or the text data attached to the specific thread or comment can be viewed at once.

Furthermore, the composing unit can generate Hyper Text Markup Language (HTML) data of a thread index, HTML data of the text data and data of the image by units of thread of the posted document, and the entire data can be packaged into one file. Therefore, when restructuring the image or the text data attached to a specific thread or comment into one document and saving the document, a compressed file of all of the data can be generated easily.

When forwarding a document from an application to another application in the document management server device, key information of the application of a forwarder is converted into random key information of the application of a forwarding destination. The user is not required to designate the key information of the application of the forwarding destination. Therefore, a document can be forwarded easily from an application to another application in the document management server device.

For example, when forwarding an image from a facsimile server to an electronic bulletin board server, communication information, which is the key information of the facsimile server, is converted automatically into a category, which is key information of the electronic bulletin board. Since the user is not required to designate a category of the electronic bulletin board, an image can be easily forwarded from the facsimile server to the electronic bulletin board server.

A document management server device includes a stylized comment storage unit that stores a stylized comment corresponding to a category of an electronic bulletin board. For example, when forwarding an image from the facsimile server to the electronic bulletin board server, a comment is generated automatically in accordance with the category. Since the user is not required to enter a comment, just by instructing to forward an image, the image can be forwarded easily from the facsimile server to the electronic bulletin board server.

For example, when forwarding an image from the facsimile server to the electronic bulletin board server, the image can be forwarded by selecting the category of the electronic bulletin board and selecting a new registration or a reply to a certain comment of the electronic bulletin board. Since the user is not required to display the electronic bulletin board each time when forwarding an image, the image can be forwarded easily from the facsimile server to the electronic bulletin board server.

### BRIEF DESCRIPTION OF THE DRAWINGS

FIG. 1 is a block diagram showing an example of a network configuration of a system in which a facsimile server is provided as a server device having an electronic bulletin board function according to an embodiment of the present invention.

FIG. 2 is a block diagram showing a hardware configuration of the facsimile server.

FIG. 3 is a functional block diagram showing the electronic bulletin board function to be executed by the facsimile server.

FIG. 4 is a flowchart showing a process of executing the electronic bulletin board function.

FIG. 5 shows a display screen of an electronic bulletin board.

FIG. 6 shows a reply screen in the electronic bulletin board.

FIG. 7 is a functional block diagram showing an electronic bulletin board function executed by a facsimile server.

FIG. 8 is a flowchart showing a process of executing the electronic bulletin board function.

FIG. 9 shows a display screen of an electronic bulletin board.

FIG. 10 shows a reply screen in the electronic bulletin board.

FIG. 11 shows a file composing instruction screen.

FIG. 12 shows a structure of a Portable Document Format (PDF) composite file.

FIG. 13 shows a structure of a Tagged Image File Format (TIFF) composite file.

FIG. 14 shows a structure of a ZIP format composite file.

FIG. 15 is a block diagram showing an example of a network configuration of a system including a document management server device according to an embodiment of the present invention.

FIG. 16 is a block diagram showing a hardware configuration of the document management server device.

FIG. 17 is a functional block diagram showing various application functions of the document management server device.

FIGS. 18A and 18B show classifications of documents managed by the document management server device.

FIG. 19 is a functional block diagram showing functions of an electronic bulletin board server of the document management server device.

FIG. 20 shows an example of a display screen of an electronic bulletin board.

FIG. 21 is a flowchart showing a process of forwarding an image by the document management server device.

FIG. 22 is a flowchart showing a process of forwarding an image by the electronic bulletin board server.

FIG. 23 shows an image forwarding instruction screen.

FIG. 24 is another flowchart showing a process of forwarding an image by the document management server device.

FIG. 25 is another flowchart showing a process of forwarding an image by the electronic bulletin board server.

### DETAILED DESCRIPTION OF THE PREFERRED EMBODIMENTS

<First Embodiment>

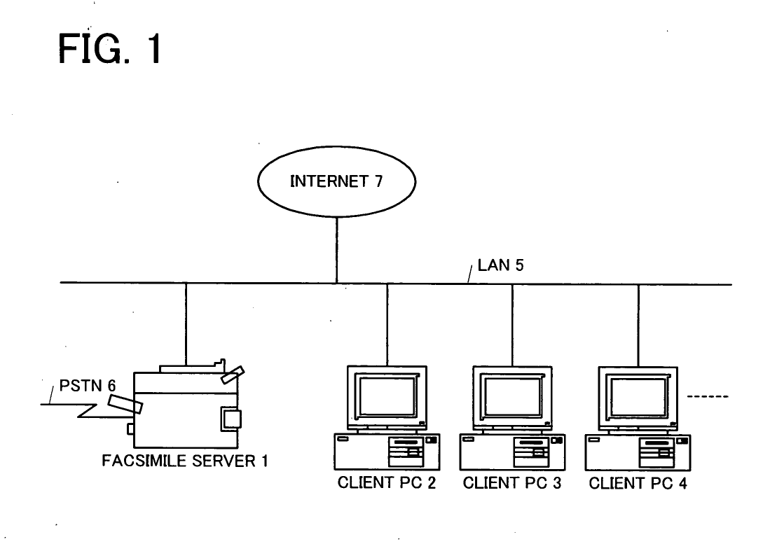

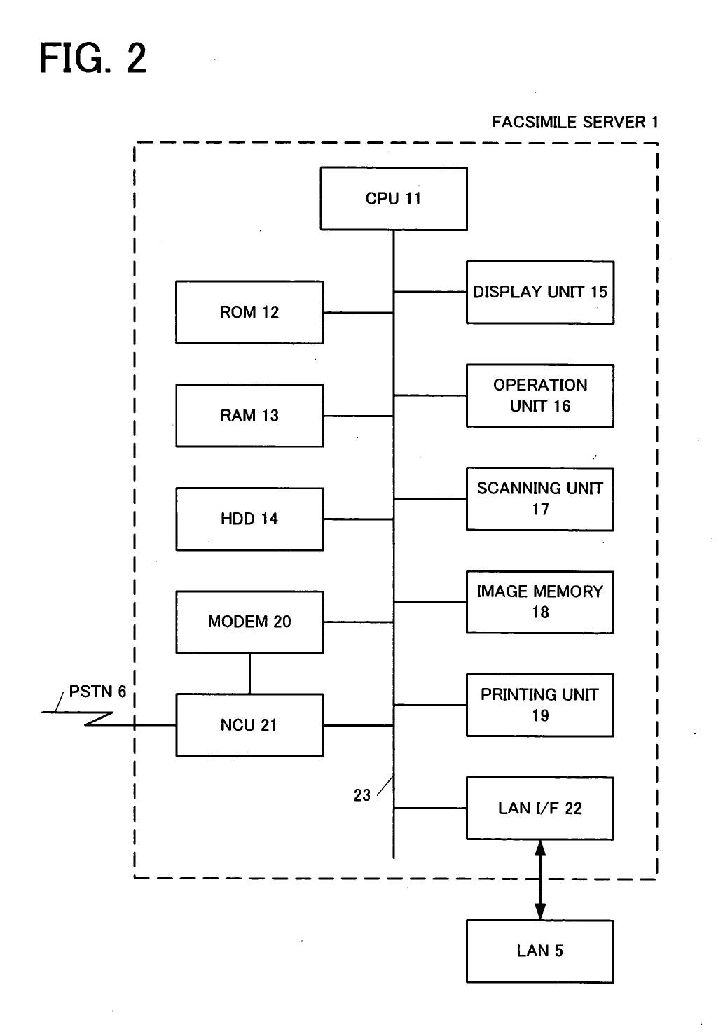

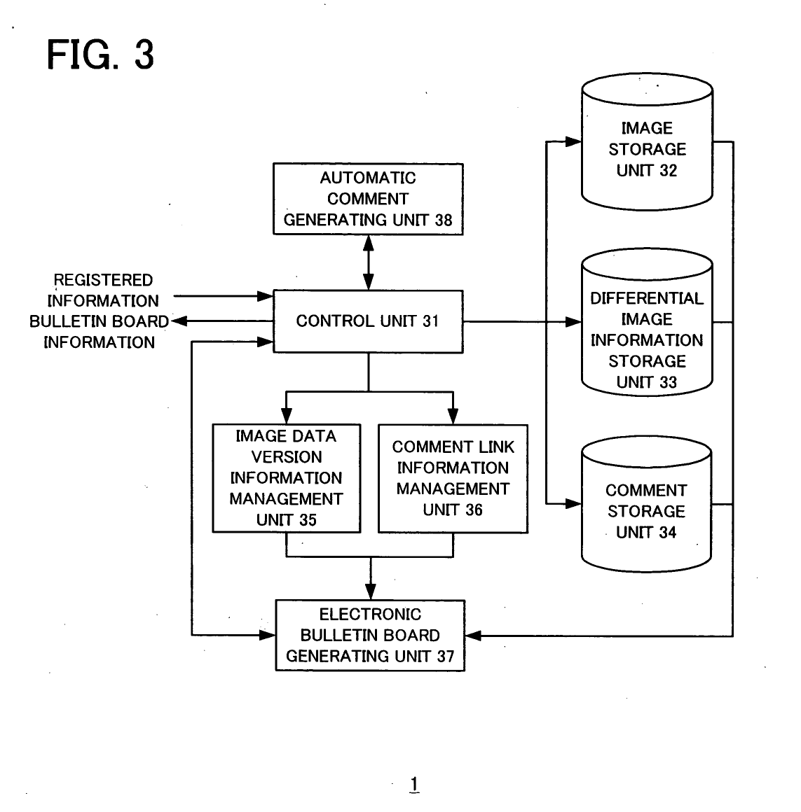

Referring to the drawings, a description will be made to a facsimile server as a server device having an electronic bulletin board function according to an embodiment of the present invention. FIG. 1 is a block diagram showing an example of a network configuration of a system including the facsimile server according to a first embodiment of the present invention. FIG. 2 is a block diagram showing a hardware configuration of the facsimile server. FIG. 3 is a functional block diagram showing functions of the facsimile server.

In FIG. 1, reference numeral 1 denotes a facsimile server, 2, 3, 4, . . . denote personal computers of clients (hereinafter referred to as the “client PC”), 5 denotes a Local Area Network (LAN), 6 denotes a Public Switched Telephone Network (PSTN), and 7 denotes the Internet. The facsimile server 1 is connected to the PSTN 6 and also connected to the LAN 5 which is one of communication networks. A plurality of client PCs 2, 3, 4, . . . are connected to the LAN 5. The LAN 5 is also connected to the Internet 7.

In accordance with respective protocols, the facsimile server 1 can forward to a client PC of a forwarding destination or another facsimile machine connected to the Internet, image data received by facsimile through the PSTN 6. The facsimile server 1 can also receive data from the client PCs 2, 3, 4, . . . and transmit the data to a transmitting destination designated by a client. Furthermore, the facsimile server 1 generates electronic bulletin board information in accordance with a document that includes an image received by facsimile, an image received from the client PCs 2, 3, 4, . . . , an image received by the Internet facsimile using electronic mail or an image scanned by a scanning unit.

Referring to FIG. 2, a description will be made to the hardware configuration of the facsimile server 1. As shown in FIG. 2, the facsimile server 1 includes a Central Processing Unit (CPU) 11, a Read Only Memory (ROM) 12, a Random Access Memory (RAM) 13, a Hard Disk Drive (HDD) 14, a display unit 15, an operation unit 16, a scanning unit 17, an image memory 18, a printing unit 19, a modem 20, a Network Control Unit (NCU) 21 and a LAN interface 22. Each of the units is connected via a bus 23.

The CPU 11 controls each of the hardware units of the facsimile server 1 via the bus 23. The CPU 11 executes various programs in accordance with a program stored in the ROM 12. The RAM 13 is formed of a Static RAM (SRAM) or the like and stores temporary data that generates when a program is executed. Further, a FLASH MEMORY can be used for the RAM 13. In this case, even when there is a power failure or even when a power source of the facsimile server 1 is shut, stored contents are not lost. The HDD 14 stores text data of a comment and image data that are registered with an electronic bulletin board. In addition, the HDD 14 stores the generated electronic bulletin board information.

The display unit 15 is a display device such as a Liquid Crystal Display (LCD) or a Cathode Ray Tube (CRT) display. The display unit 15 displays operational status of the facsimile server 1 and displays an operation screen of various functions. The operation unit 16 includes various function keys, such as letter keys, a ten-key numeric pad, a speed dial keys and a help key, that are necessary for operating the facsimile server 1. Further, by forming the display unit 15 as a touch panel, a part of all of the various keys of the operation unit 16 can be substituted.

The scanning unit 17 scans an original document by a scanner using a Charge Coupled Device (CCD) or the like and outputs dot image data converted into a binary of black and white. The image memory 18 is formed of a Dynamic RAM (DRAM) or the like and stores image data to be transmitted or received image data. The printing unit 19 includes an electro-photographic printing device and prints out the received data as hardcopy.

The modem 20 is connected to the bus 23 and includes a function as a faxmodem that can carry out facsimile communication. The modem 20 is connected to the NCU 21 that is also connected to the bus 23. The NCU 21 is a hardware that closes and releases an analog line. The NCU 21 connects the modem 20 to the PSTN 6 when necessary. The LAN interface 22 is connected to the LAN 5. The LAN interface 22 receives a signal or data from the LAN 5 and transmits a signal or data to the LAN 5. The LAN interface 22 executes an interface process such as a signal conversion or a protocol conversion.

The facsimile server 1 is formed as described above. When carrying out facsimile transmission, the scanning unit 17 scans image data of an original document and the scanned data is accumulated in the image memory 18. Then, the data is modulated by the modem 20 and transmitted from the NCU 21 through the PSTN 6 to a destination. When carrying out facsimile reception, received image data is demodulated by the modem 20, accumulated in the image memory 18, and printed out by the printing unit 19.

FIG. 3 is a functional block diagram showing each of units that executes the electronic bulletin board function of the facsimile server 1. The facsimile server 1 includes a control unit 31, an image storage unit 32, a differential image information storage unit 33, a comment storage unit 34, an image data version information management unit 35, a comment link information management unit 36, an electronic bulletin board information generating unit 37 and an automatic comment generating unit 38.

When a comment and an image are registered, the control unit 31 provides identification information to the registered image and comment. Then, a new image provided with the identification information is stored in the image storage unit 32. An edited part of the edited image is stored in the differential image information storage unit 33. The comment is stored in the comment storage unit 34. Furthermore, link information of the new image stored in the image storage unit 32 and the differential image stored in the differential image information storage unit 33, and link information of each comment are generated. Each of the link information is transmitted to the image data version information management unit 35 and the comment link information management unit 36, respectively.

When a comment or an image is newly registered, or when there is a reply of the comment or when the image is edited, the control unit 31 instructs the electronic bulletin board information generating unit 37 to generate new electronic bulletin board information. The electronic bulletin board information generated by the electronic bulletin board information generating unit 37 is transmitted to a client PC.

Furthermore, as a reply, when there is only a reply of a new image or a reply of an edited image and there is no reply of a comment, the control unit 31 instructs the automatic comment generating unit 38 to generate a comment indicating a reply of a new image or a reply of an edited image.

The image storage unit 32 stores image data of a new image registered with the electronic bulletin board.

When an image posted on the electronic bulletin board is edited, the differential image information storage unit 33 stores differential information of an image before being edited and an image after being edited.

The comment storage unit 34 stores text data consisting of a title and a main text of a newly registered comment or a reply comment.

The image data version information management unit 35 generates a link of an image, in other words, version information, in accordance with the link information of the image generated by the control unit 31, and stores the version information.

The comment link information management unit 36 generates a link of the comment in accordance with the link information of the comment generated by the control unit 31, and stores the link of the comment.

The electronic bulletin board information generating unit 37 generates electronic bulletin board information in accordance with the link information from the comment link information management unit 36 and the image data version information management unit 35, and the information from the image storage unit 32, the differential image information storage unit 33 and the comment storage unit 34. Further, the generated electronic bulletin board information includes information of a title of a comment for each thread, an image icon, a title and a main text of a currently selected comment and an image in case an image is attached to the comment, and also information of a thumbnail list display of all images included in a selected thread.

When there is a reply of an edited image or a new image, in case a comment is not attached to the reply, the automatic comment generating unit 38 selects from stored stylized comments, a comment indicating that there has been a reply of an edited image or a new image, and automatically generates a comment.

Each of the units is formed of the CPU 11, the ROM 12, the RAM 13 and the HDD 14 of FIG. 2. The function of each of the units is executed by a software program.

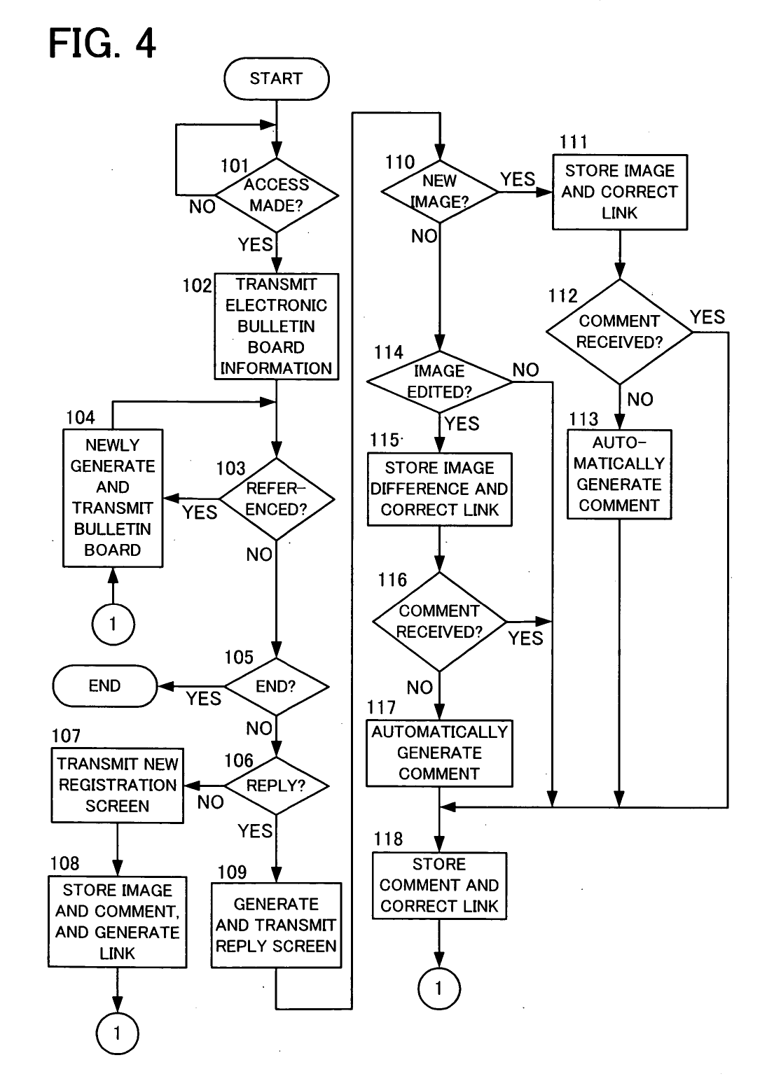

Next, referring to the functional block diagram of FIG. 3 and the flowchart of FIG. 4, a description will be made to a process carried out by the facsimile server 1 when a comment or an image is registered with the electronic bulletin board, when a reply is sent, or when an image is edited.

When a user accesses to the electronic bulletin board by using the client PC 2, the control unit 31 determines that an access has been made (step 101). Then, the electronic bulletin board information including the registered comment and the image information is transmitted to the client PC 2 (step 102).

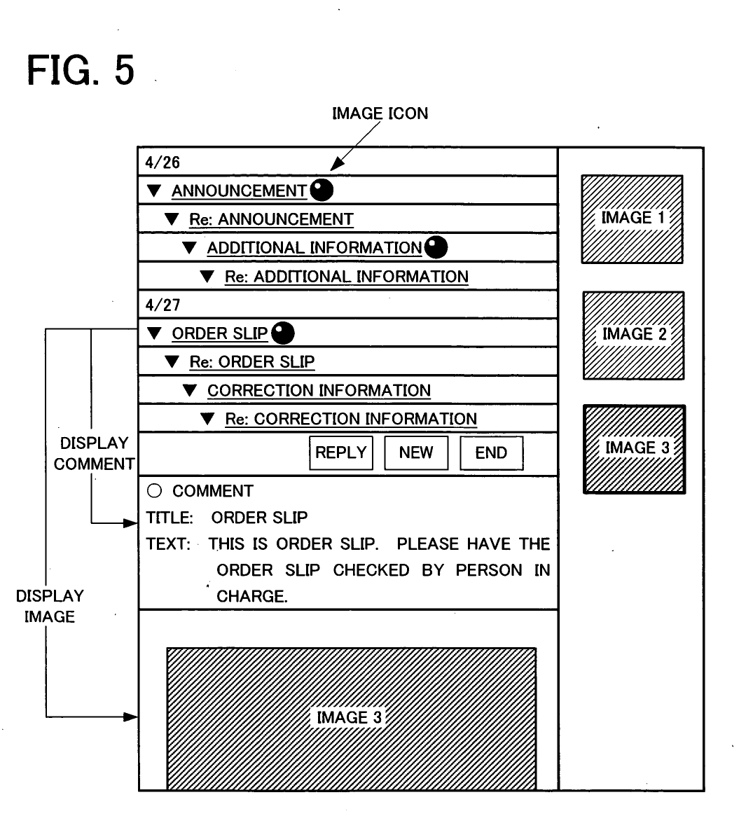

When the user clicks and references a title among titles displayed in a thread on the electronic bulletin board, the control unit 31 determines that a reference has been made (step 103). The control unit 31 instructs the electronic bulletin board information generating unit 37 to newly generate electronic bulletin board information including a main text of the comment and an image, and transmits the generated electronic bulletin board information to the client PC 2 (step 104). As a result, an electronic bulletin board as shown in FIG. 5 is displayed on a display screen of the client PC 2.

As shown in FIG. 5, in an upper part of the electronic bulletin board, a list of titles of a thread display arranged in an order of the thread is displayed. When a new image is attached to a comment, or when there is an edited image, an image icon is displayed next to the title of such a comment. This thread display expresses a parent-child relationship of each comment. When someone replies to a certain comment, the reply comment becomes a child deriving from the original comment.

As shown in the drawing, with respect to a title of a certain comment, a title of a reply comment to that comment is indented. In the same manner, a title of a reply to this comment is further indented. The entire group of comments that derived from one comment by such a relationship of replies or the like is a thread. In the example shown in FIG. 5, two threads are displayed.

Below the title list screen of the thread display, the title and the main text of the currently selected comment and an image, in case an image is attached to the comment, are displayed.

In a right side of the electronic bulletin board screen, a list of all images included in the selected thread is displayed as a thumbnail. A focus is placed on an image (in the drawing, an image 3) that is a base of the displayed comment. By clicking one of the images among the thumbnail displayed list, an image and a comment corresponding to the thumbnail display can be referenced.

When the user clicks “REPLY”, “NEW” or “END” at a center of the screen, this information is transmitted to the facsimile server 1. The control unit 31 of the facsimile server 1 determines whether or not “END” has been clicked (step 105). When “END” has been clicked, the control unit 31 ends the program. Meanwhile, when “END” has not been clicked, the control unit 31 determines whether “REPLY” or “NEW” has been clicked (step 106). When “NEW” has been clicked, a new registration screen (not shown) is transmitted to the client PC 2 (step 107).

When the user inputs an image and a comment in the new registration screen and transmits the image and the comment, the control unit 31 provides identification information to the transmitted image and comment. The image provided with the identification information is stored in the image storage unit 32. The comment provided with the identification information is stored in the comment storage unit 34. In addition, the link information of the image and the link information of the comment are generated newly and transmitted to the image data version information management unit 35 and the comment link information management unit 36, respectively (step 108).

Then, the control unit 31 instructs the electronic bulletin board information generating unit 37 to generate new electronic bulletin board information. The electronic bulletin board information generating unit 37 generates electronic bulletin board information in accordance with the link information from the comment link information management unit 36 and the image data version information management unit 35 and the information from the image storage unit 32, the differential image information storage unit 33 and the comment storage unit 34. Then, the control unit 31 transmits the newly generated electronic bulletin board information to the client PC 2 (step 104).

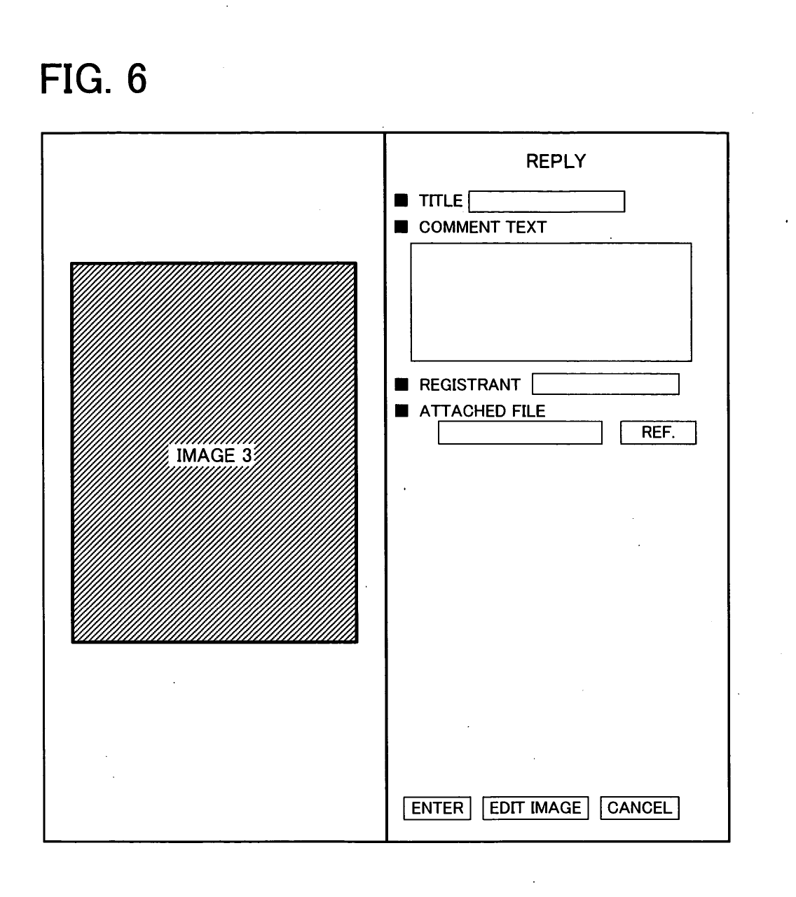

Meanwhile, when the user clicks “REPLY”, the control unit 31 instructs the electronic bulletin board information generating unit 37 to generate a reply screen shown in FIG. 6 and transmits the reply screen to the client PC (step 109). As shown in FIG. 6, in a left side of the reply screen, an image of the selected comment is displayed. In a right side of the reply screen, there are a title input section for inputting the title of the reply comment, a main text input section, a registrant input section for inputting a name of the registrant and an input section for inputting an attached file of a new image or the like.

In the reply screen, when the user inputs a reply comment and clicks “ENTER”, the reply comment is transmitted to the facsimile server 1.

By clicking “REF.” in the attached file section, a list of files is displayed. Then, by selecting a corresponding file from the list, an image can be selected. Then, when “ENTER” is clicked, the selected file is transmitted to the facsimile server 1 as a new image.

When the user clicks “EDIT IMAGE”, the image displayed at the left side becomes capable of being edited. After the user edits the image by filling a marker in the image or attaching a label image or the like, when “ENTER” is clicked, the edited information is transmitted to the facsimile server 1.

Then, the control unit 31 of the facsimile server 1 determines whether or not there is a new image in accordance with the received information (step 110). When there is a new image, the control unit 31 provides identification information to the received image and stores the image provided with the identification information in the image storage unit 32. Then, the control unit 31 transmits to the image data version information management unit 35, link information that links the image to the original image. The image data version information management unit 35 generates and stores new version information of the image (step 111).

Next, the control unit 31 determines whether or not a comment has been received (step 112). When a comment has been received, identification information is provided to the comment and the comment provided with the identification information is stored in the comment storage unit 34. Then, link information that links the comment to the original comment is transmitted to the comment link information management unit 36. The comment link information management unit 36 generates new comment link and stores the newly generated comment link.

Meanwhile, when a comment has not been received, the control unit 31 instructs the automatic comment generating unit 38 to generate a comment of a new image reply (step 113).

The automatic comment generating unit 38 selects a title “ADDITIONAL INFORMATION” and a main text “An image has been added.” from the registered comment information and transmits the selected title and main text to the control unit 31. The control unit 31 provides identification information to the comment and stores the comment in the comment storage unit 34. In addition, the control unit 31 transmits the comment link information to the comment link information management unit 36 (step 118).

Then, in the same manner as in the new registration, the control unit 31 instructs the electronic bulletin board information generating unit 37 to generate new electronic bulletin board information. The control unit 31 transmits the newly generated electronic bulletin board information to the client PC 2 (step 104).

Meanwhile, when the control unit 31 determined at step 110 that there is no new image, the control unit 31 determines whether or not an image has been edited (step 114). When an image has not been edited, there is a reply of only a comment. Therefore, the control unit 31 provides identification information to the comment. The control unit 31 stores the comment provided with the identification information in the comment storage unit 34 and transmits link information that links the comment to the original comment to the comment link information management unit 36 (step 118). Then, in the same manner as described above, the control unit 31 instructs the electronic bulletin board information generating unit 37 to generate new electronic bulletin board information and transmits the newly generated electronic bulletin board information to the client PC 2 (step 104).

When it is determined at step 114 that an image has been edited, identification information is provided to the edited image such as a label image or a written marker. Then, the image provided with the identification information is stored in the differential image information storage unit 33. The link information that links the differential image to the original image is transmitted to the image data version information management unit 35. The image data version information management unit 35 generates and stores new version information of the image.

Next, the control unit 31 determines whether or not a comment has been received (step 116). When a comment has been received, the control unit 31 provides identification information to the comment and stores the comment provided with the identification information in the comment storage unit 34. In addition, the control unit 31 transmits to the comment link information management unit 31, link information that links the comment to the original comment (step 118). Meanwhile, when a comment has not been received, the control unit 31 instructs the automatic comment generating unit 38 to generate a comment of the edited image (step 117).

The automatic comment generating unit 38 selects a title “CORRECTION INFORMATION” and a main text “The image has been edited.” from the registered comment information and transmits the selected title and main text to the control unit 31. The control unit 31 provides identification information to the comment. The control unit 31 stores the comment provided with the identification information in the comment storage unit 34. In addition, the control unit 31 transmits to the comment link information management unit 36, link information that links the comment to the original comment (step 118).

In the same manner as described above, the control unit 31 instructs the electronic bulletin board information generating unit 37 to generate new electronic bulletin board information and transmits the newly generated electronic bulletin board information to the client PC 2 (step 104). As described above, when there is a reply indicating that an image has been edited or a new image has been registered and there is no reply of a comment, a comment consisting of a title and a main text indicating that an image has been edited or a new image has been registered is generated automatically. Therefore, the user who looks at the electronic bulletin board thereafter can easily recognize that an image has been edited or a new image has been registered.

Furthermore, a name of an editor of the image or an edited part can be written in the main text of the comment that is generated automatically. In this case, even more effective information can be presented to the user.

In the above-described embodiment, a facsimile server is provided as the server device having the electronic bulletin board function of the present invention. However, the server device having the electronic bulletin board function of the present invention is not limited to the facsimile server and can be a general server device or a personal computer.

In addition, in the above-described embodiment, when there is only a reply indicating that an image has been edited or a new image has been registered, a comment consisting of a title and a main text indicating such a fact is generated. However, since the title is sufficient for recognizing that there has been a reply indicating that an image has been edited or a new image has been registered, the main text is not always required to be generated.

Furthermore, in the above-described embodiment, the differential image information storage unit is provided, and when an image is edited, the differential information of the edited image and the original image is stored in the differential image information storage unit. However, the whole edited image can be stored in the image storage unit that is the same as the image storage unit of the new image.

<Second Embodiment>

Next, a second embodiment of the present invention will be described. A hardware configuration of a facsimile server 201 of the second embodiment is the same as that of the facsimile server 1 of FIG. 2. Since the facsimile server 201 is used in the same network environment as in FIG. 1, the description on the network environment will be omitted.

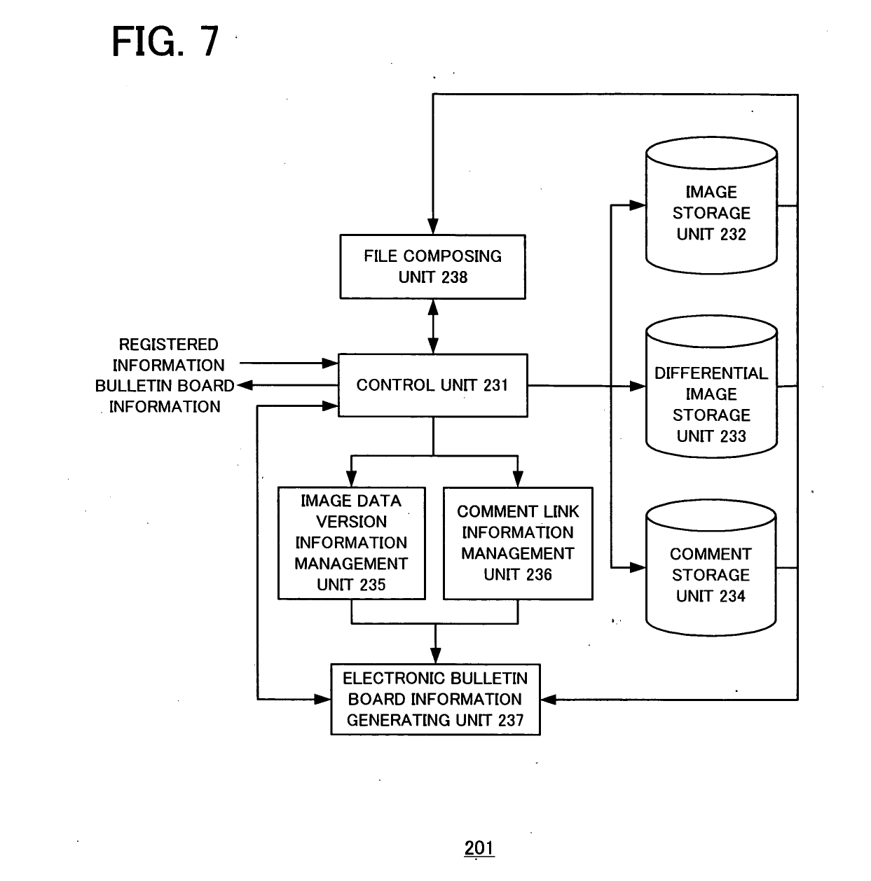

FIG. 7 is a functional block diagram showing each unit that executes an electronic bulletin board function of the facsimile server 201.

The facsimile server 201 includes a control unit 231, an image storage unit 232, a differential image storage unit 233, a comment storage unit 234, an image data version information management unit 235, a comment link information management unit 236, an electronic bulletin board information generating unit 237 and a file composing unit 238.

When a comment and an image are registered, the control unit 231 provides identification information to the registered image and comment. The newly registered image provided with the identification information is stored in the image storage unit 232. The edited part of the edited image is stored in the differential image storage unit 233. The comment is stored in the comment storage unit 234. Furthermore, the control unit 231 generates link information of the new image stored in the image storage unit 232 and the differential image stored in the differential image storage unit 233, and link information of each comment. Then, the control unit 231 transmits each of the link information to the image data version information management unit 235 and the comment link information management unit 236, respectively. When a comment or an image is newly registered, or when there is a reply of a comment or when an image is edited, the control unit 231 instructs the electronic bulletin board information generating unit 237 to generate new electronic bulletin board information, and transmits the electronic bulletin board information generated by the electronic bulletin board information generating unit 237 to a client PC. Furthermore, when collectively displaying, storing, printing or transmitting image data or text data attached to a specific thread or comment, the control unit 231 instructs the file composing unit 238 to form a composite file of the data.

The image storage unit 232 stores image data of the new image registered with the electronic bulletin board.

When an image posted on the electronic bulletin board is edited, the differential image storage unit 233 stores image data of a difference between an image before being edited and an image after being edited.

The comment storage unit 234 stores text data consisting of a title and a main text of a newly registered comment or a reply comment.

The image data version information management unit 235 generates a link of an image, in other words, version information, in accordance with the link information of the image generated by the control unit 231, and stores the generated version information.

The comment link information management unit 236 generates and stores a link of a comment in accordance with the link information of the comment generated by the control unit 231.

The electronic bulletin board information generating unit 237 generates electronic bulletin board information in accordance with the link information from the comment link information management unit 236 and the image data version information management unit 235 and the information from the image storage unit 232, the differential image storage unit 233 and the comment storage unit 234. Further, the generated electronic bulletin board information includes a title of a comment for each thread, an image icon, a title and a main text of a currently selected comment and an image in case an image is attached to the comment, and also includes a thumbnail list display of all images included in the selected thread.

The file composing unit 238 composes a file of an image or text data attached to a specific thread or comment into a ZIP file or a Portable Document Format (PDF) file or the like and outputs the composite file.

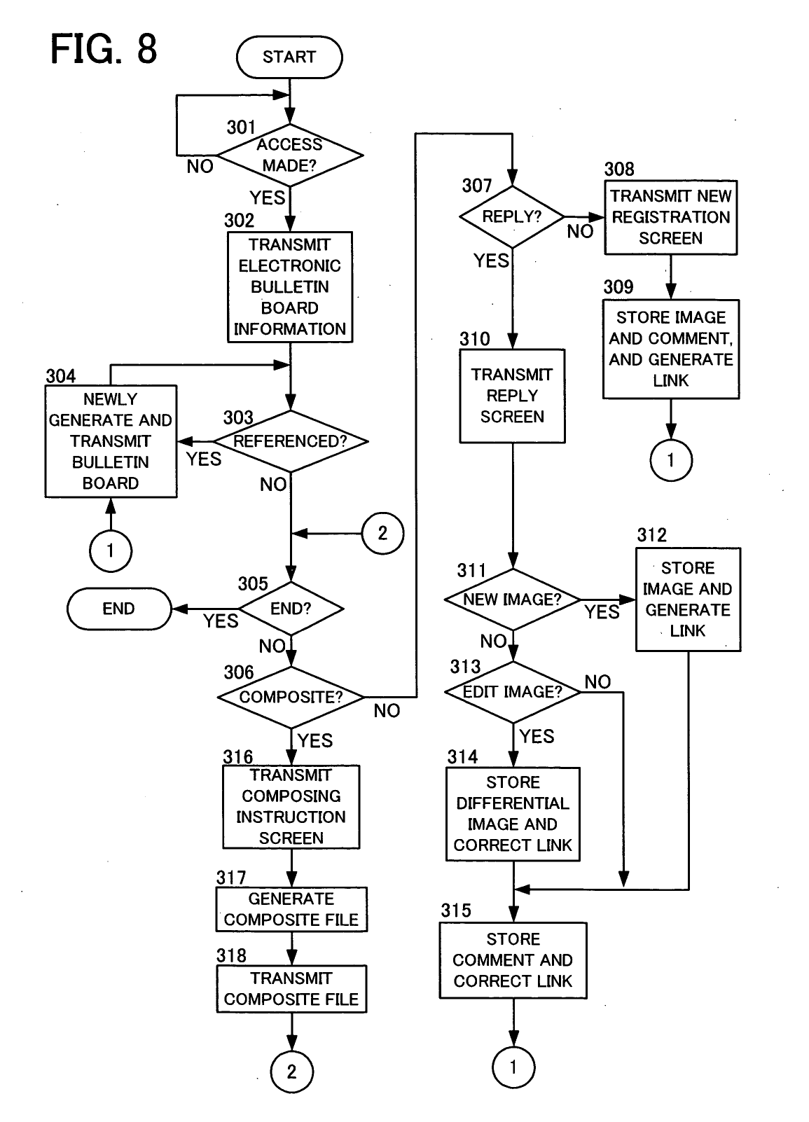

Next, referring to the functional block diagram of FIG. 7 and the flowchart of FIG. 8, a description will be made to a process of the facsimile server 201 when a comment or an image is registered with the electronic bulletin board, when a reply is sent, or when an image is edited or a file is composed.

When a user accesses the electronic bulletin board by using the client PC 2, the control unit 231 determines that an access has been made (step 301). Then, the control unit 231 transmits electronic bulletin board information including the registered comment and image information to the client PC 2 (step 302).

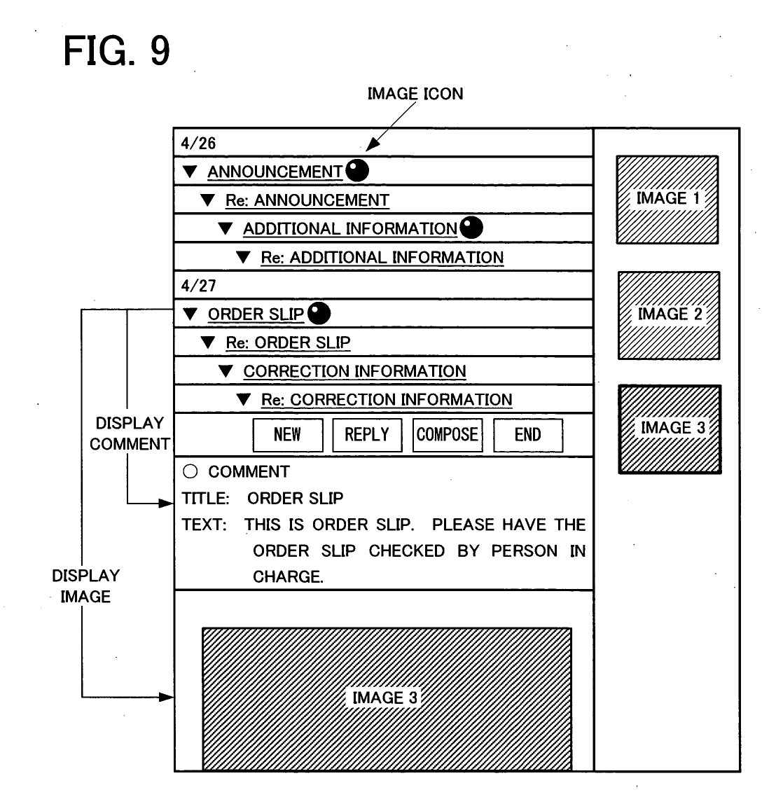

When the user clicks and references a certain title among titles display in a thread on the electronic bulletin board, the control unit 231 determines that a reference has been made (step 303). The control unit 231 instructs the electronic bulletin board information generating unit 237 to generate electronic bulletin board information that includes a main text and an image of the referenced comment. Then, the control unit 231 transmits the generated electronic bulletin board information to the client PC 2 (step 304). Accordingly, an electronic bulletin board as shown in FIG. 9 is displayed on a display screen of the client PC 2.

As shown in FIG. 9, in an upper part of the electronic bulletin board, a list of titles of a thread display arranged in an order of the thread is displayed. When a new image is attached to a comment, or when there is an edited image, an image icon is displayed next to the title of such a comment. This thread display expresses a parent-child relationship of each comment. When someone replies to a certain comment, the reply comment becomes a child deriving from the original comment.

As shown in the drawing, with respect to a title of a certain comment, a title of a reply comment to that comment is indented. In the same manner, a title of a reply to this title is further indented. The entire group of comments that derived from one comment by such a relationship of relies or the like is a thread. In the example shown in FIG. 9, two threads are displayed.

Below the title list screen of the thread display, the title and the main text of the currently selected comment and an image, in case an image is attached to the comment, are displayed.

In a right side of the electronic bulletin board screen, a list of all images included in the selected thread is displayed as a thumbnail. A focus is placed on an image (in the drawing, an image 3) that is a base of the displayed comment. By clicking one of the images among the thumbnail displayed list, an image and a comment corresponding to the thumbnail display can be referenced.

When the user clicks “NEW”, “EWPLY”, “COMPOSE” or “END” at a center of the screen, this information is transmitted to the facsimile server 201. The control unit 231 of the facsimile server 201 determines whether or not “END” has been clicked (step 305). When “END” has been clicked, the control unit 231 ends the program.

Meanwhile, when “END” has not been clicked, the control unit 231 determines whether “COMPOSE” has been clicked (step 306). When “COMPOSE” has not been clicked, the control unit 231 determines whether “REPLY” or “NEW” has been clicked (step 307).

When “NEW” has been clicked, a new registration screen (not shown) is transmitted to the client PC (step 308). The user inputs an image and a comment in the new registration screen and transmits the image and the comment. Then, the control unit 231 provides identification information to the transmitted image and comment. The image provided with the identification information is stored in the image storage unit 232. The comment provided with the identification information is stored in the comment storage unit 234. The link information of the image and the link information of the comment are generated newly and transmitted to the image data version information management unit 235 and the comment link information management unit 236, respectively (step 309).

Then, the control unit 231 instructs the electronic bulletin board information generating unit 237 to generate new electronic bulletin board information. The electronic bulletin board information generating unit 237 generates electronic bulletin board information in accordance with the link information from the comment link information management unit 236 and the image data version information management unit 235 and the information from the image storage unit 232, the differential image information storage unit 233 and the comment storage unit 234. Then, the control unit 231 transmits the newly generated electronic bulletin board information to the client PC 2 (step 304).

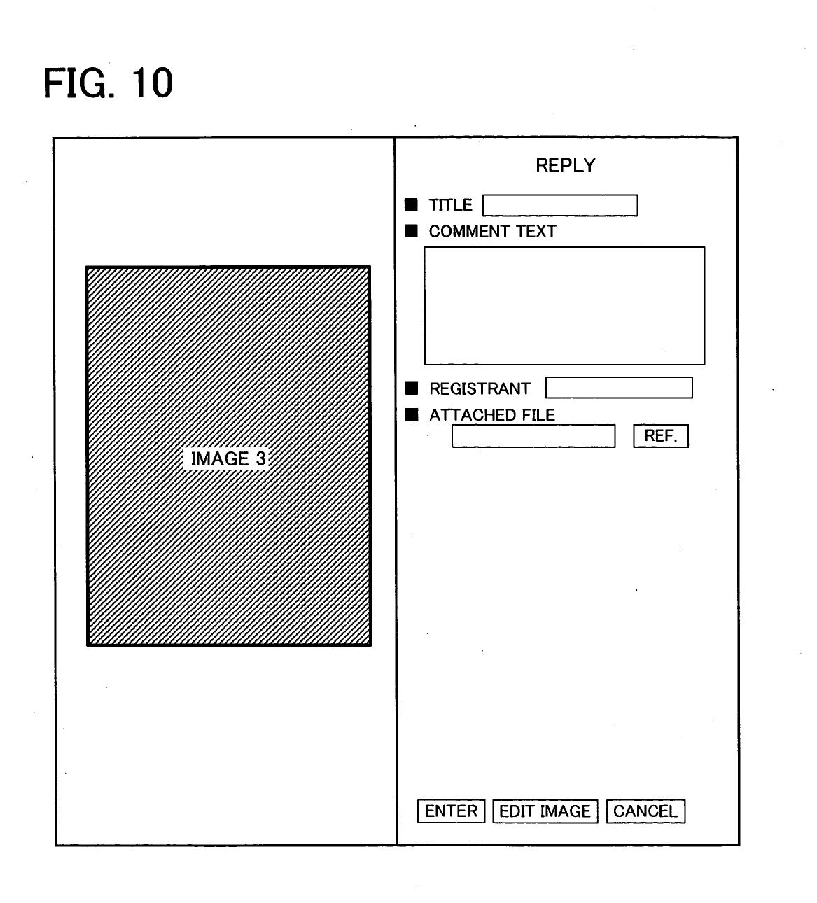

Meanwhile, when the user clicks “REPLY”, the control unit 231 instructs the electronic bulletin board information generating unit 237 to generate a reply screen shown in FIG. 10 and transmits the reply screen to the client PC 2 (step 310). As shown in FIG. 10, in a left side of the reply screen, an image of the selected comment is displayed. In a right side of the reply screen, there are a title input section for inputting the title of the reply comment, a main text input section, a registrant input section for inputting a name of the registrant and an input section for inputting an attached file of a new image or the like.

In the reply screen, when the user inputs a reply comment and clicks “ENTER”, the reply comment is transmitted to the facsimile server 201. By clicking “REF.” in the attached file section, a list of files is displayed. Then, by selecting a corresponding file from the list, an image can be selected. When “ENTER” is clicked, the selected file is transmitted to the facsimile server 201 as a new image.

When the user clicks “EDIT IMAGE”, the image displayed at the left side becomes capable of being edited. After the user edits the image by filling a marker in the image or attaching a label image or the like, when “ENTER” is clicked, the edited information is transmitted to the facsimile server 201.

Then, the control unit 231 of the facsimile server 201 determines whether or not there is a new image in accordance with the received information (step 311). When there is a new image, the control unit 231 provides identification information to the received image and stores the image provided with the identification information in the image storage unit 232. Then, the control unit 231 transmits to the image data version information management unit 235, link information that links the image to the original image. The image data version information management unit 235 generates and stores new version information of the image (step 312).

Next, the control unit 231 provides identification information to the received comment. The text data of the comment provided with the identification information is stored in the comment storage unit 234. Then, link information that links the comment to the original comment is transmitted to the comment link information management unit 236. The comment link information management unit 236 generates new comment link and stores the newly generated comment link (step 315).

Then, in the same manner as in the new registration, the control unit 231 instructs the electronic bulletin board information generating unit 237 to generate new electronic bulletin board information. The control unit 231 transmits the newly generated electronic bulletin board information to the client PC 2 (step 304).

Meanwhile, when the control unit 231 determined at step 311 that there is no new image, the control unit 231 determines whether or not an image has been edited (step 114). When an image has not been edited, there is a reply of only a comment. Therefore, the control unit 231 provides identification information to the comment. The control unit 231 stores the comment provided with the identification information in the comment storage unit 234 and transmits link information that links the comment to the original comment to the comment link information management unit 236 (step 315). Then, in the same manner as described above, the control unit 231 instructs the electronic bulletin board information generating unit 237 to generate new electronic bulletin board information and transmits the newly generated electronic bulleting board information to the client PC 2 (step 304).

When it is determined at step 313 that an image has been edited, identification information is provided to the edited image such as a label image or a written marker. Then, the image provided with the identification information is stored in the differential image information storage unit 233. The link information that links the differential image to the original image is transmitted to the image data version information management unit 235. The image data version information management unit 235 generates and stores new version information of the image (step 314). Then, the process proceeds to step 315.

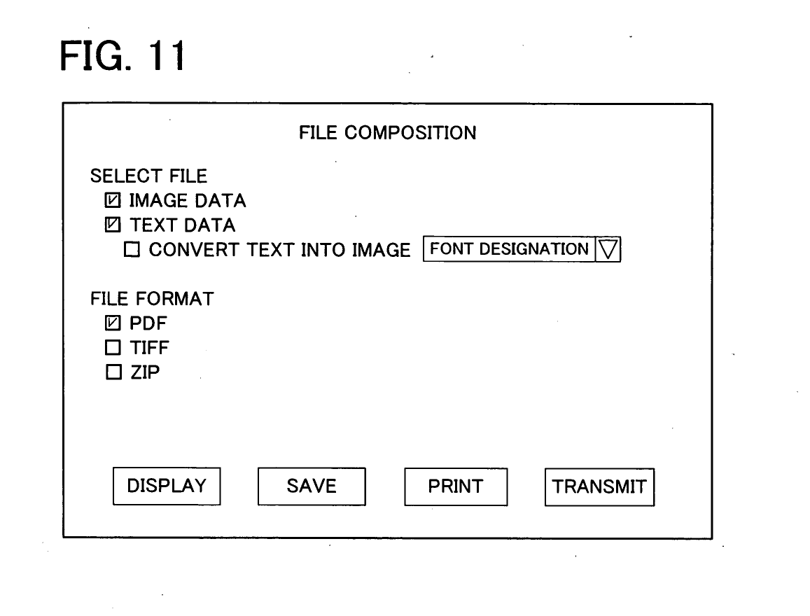

Meanwhile, at step 306, when it is determined that the “COMPOSE” has been clicked, the control unit 231 transmits a file composing instruction screen shown in FIG. 11 to the client PC 2 (step 316).

As shown in FIG. 11, in an upper part of the file composing instruction screen, there is a display for selecting image data and text data in the selected thread or the selected comment. By clicking a white box (“□”) at a left side, the user can select only the image data, the text data, or both the image data and the text data.

When composing the text data, by clicking a white box (“□”) to the left of “CONVERT TEXT INTO IMAGE”, the text data can be converted into an image and composed. In this case, a font can be designated from “FONT DESIGNATION” section at the right side.

Meanwhile, in a lower part of the file composing instruction screen, there is a display for selecting a file format for when saving and transmitting the composite file. The file format can be selected by clicking a white box (“□”) at a left side for either a PDF format, a Tagged Image File Format (TIFF) or a ZIP format.

Furthermore, in a lowermost part of the file composing instruction screen, there is a “DISPLAY” icon for displaying the composite file at the client PC, a “SAVE” icon for saving the composite file, a “PRINT” icon for printing the composite file and a “TRANSMIT” icon for transmitting the composite file. After selecting the data to be composed and the file format, by clicking either one of the icons, a corresponding operation is executed. Further, when the user clicks the “SAVE” icon or the “TRANSMIT” icon, a designation screen for designating where to save or where to transmit is displayed. On the designation screen, when the user clicks “REFERENCE” at a storage area section or a transmitting destination section, a list of storage areas or transmitting destinations is displayed. By selecting a corresponding part from the list, the user can designate where to save or where to transmit.

Next, a description will be made to a case where under a state in which the entire thread of “ANNOUNCEMENT” of FIG. 9 is selected, when the user clicks the “COMPOSE” icon, selects both the image data and the text data in the file composing instruction screen of FIG. 11, selects PDF as the file format and clicks the “SAVE” icon.

Further, to select the entire thread or a plurality of comments, the entire thread or the plurality of comments can be selected by using a mouse or the like in the display screen of FIG. 9.

When the above information is transmitted from the client PC to the facsimile server 201, the identification information of the image data file and the text data file included in the selected entire thread is transmitted to the file composing unit 238. Then, the file composing unit 238 is instructed to form a PDF file that includes all of the data (step 317).

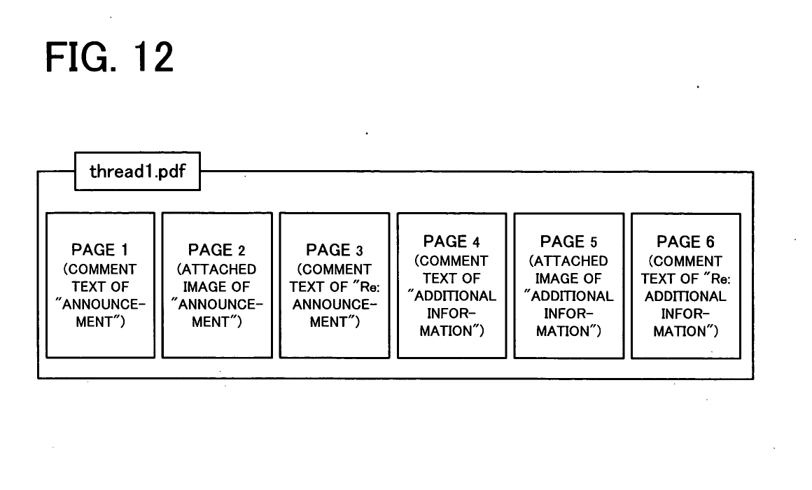

The file composing unit 238 retrieves corresponding image data file and text data file from the image storage unit 232, the differential image storage unit 233 and the comment storage unit 234 in accordance with the identification information transmitted form the control unit 231. As shown in FIG. 12, a PDF file (thread1.pdf) as a mixed document of the text and the image is formed and transmitted to the control unit 231. Further, the PDF file includes a comment text of “ANNOUNCEMENT” in Page 1, an attached image of “ANNOUNCEMENT” in Page 2, a comment text of “Re: ANNOUNCEMENT” in Page 3 and so forth.

When the control unit 231 receives the formed PDF file, the control unit 231 transmits the PDF file to the client PC 2 (step 318). The client PC 2 stores the received PDF file in the designated storage area.

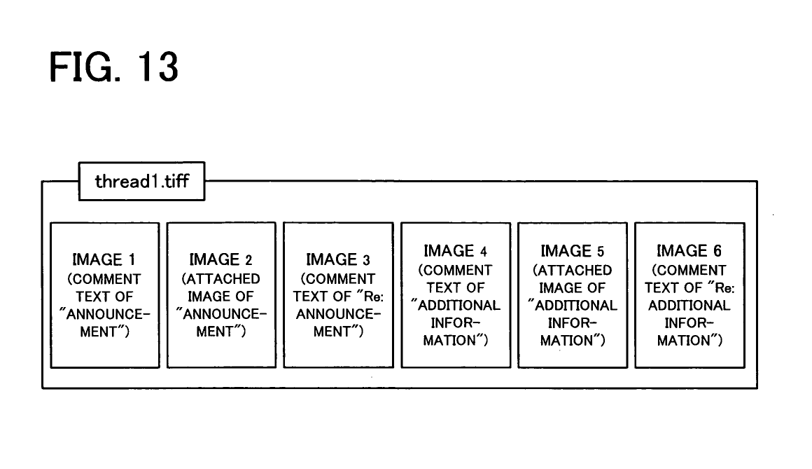

In the file composing instruction screen of FIG. 11, when the user selects both the image data and the text data, designates “CONVERT TEXT INTO IMAGE” and designates a TIFF format as the file format, a TIFF file (thread1.tiff) in which the text is also converted into an image is formed. In the example shown in FIG. 13, the TIFF file (thread1.tiff) includes an image converted from the comment text of the “ANNOUNCEMENT” as an image 1, an attached image of the “ANNOUNCEMENT” as an image 2, an image converted from the comment text of “Re: ANNOUNCEMENT” as an image 3, and so forth. In this case, the comment text is converted into an image by the font designated in the “FONT DESIGNATION” section of the file composing instruction screen of FIG. 11.

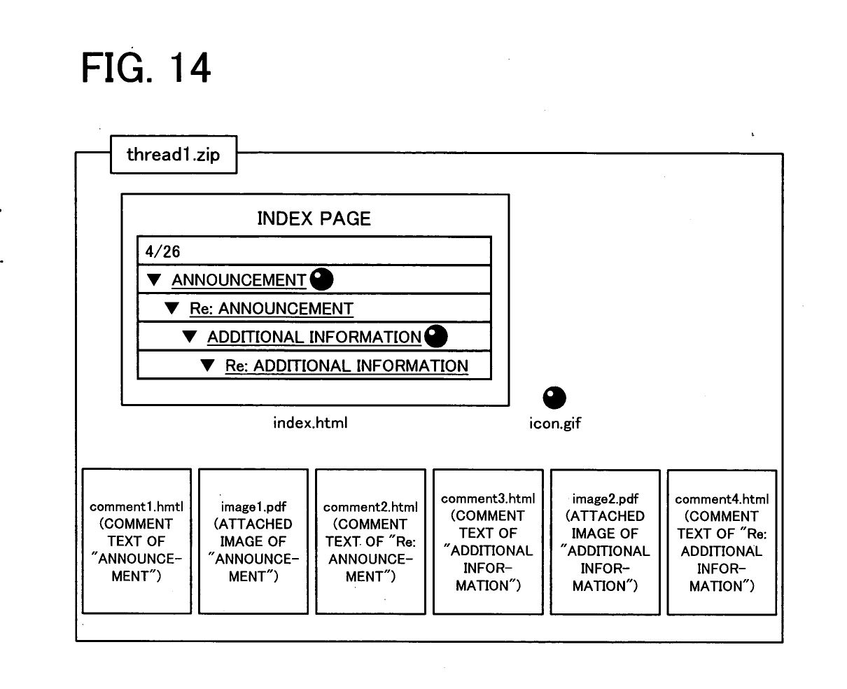

When the user designated the ZIP format as the file format, a compressed file (thread1.zip) is formed. As shown in FIG. 14, the compressed file (thread1.zip) includes a thread index page (index.html), an icon image (icon.gif), a comment text of the “ANNOUNCEMENT” (comment1.html), an attached image of the “ANNOUNCEMENT” (image1.pdf) and so forth. As described above, when the ZIP format is designated, a thread structure can be included in the index page and saved. Since a link to each page is provided in the index page, any image and any comment text can be opened easily.

Meanwhile, in the file composing instruction screen of FIG. 11, when the “DISPLAY” icon or the “PRINT” icon is clicked, the file composing unit 238 forms a file of HTML data, in other words, an HTML data document that consists of text data sandwiched by a control code indicating that the data is characters and a control code including a file name. As described above, with respect to the character string, the HTML data document is expressed as the text data. With respect to the image data, the HTML data document is expressed by the control code consisting of the file name corresponding to a number of the image. By transmitting the HTML data document and the image data to the personal computer, when the “DISPLAY” icon is clicked, the selected image and the title and the main text of the comment are displayed in a thumbnail list on the electronic bulletin board. When the “PRINT” icon is clicked, all of the images and the comments in the thread are printed out.

As described above, the file composing unit can form a composite file by randomly selecting the image data or the text data attached to a specific thread or comment. Therefore, the image or the text data attached to a specific thread or comment can be restructured into one document, and the document can be easily displayed, saved, printed, transmitted, etc.

In the above-described embodiment, a facsimile server is provided as the server device having the electronic bulletin board function of the present invention. However, the server device having the electronic bulletin board function of the present invention is not limited to the facsimile server and can be a general server device or a personal computer.

In the above-described embodiment, the PDF format, the TIFF format and the ZIP format are used as the file format that can be designated when composing a file. However, other file formats can also be used.

Furthermore, in the above-described embodiment, the differential image storage unit is provided, and when an image is edited, the difference between the edited image and the original image is stored in the differential image storage unit. However, the whole edited image can be stored in the image storage unit that is the same as the image storage unit of the new image.

<Third Embodiment>

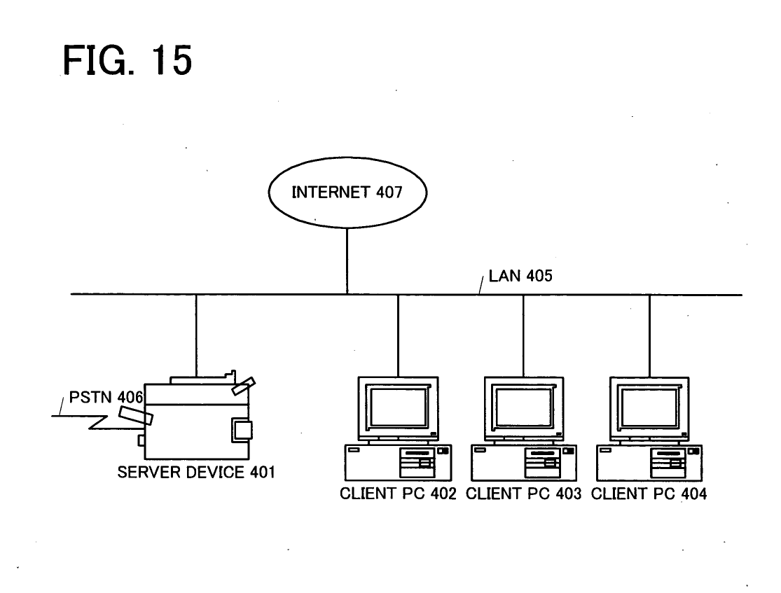

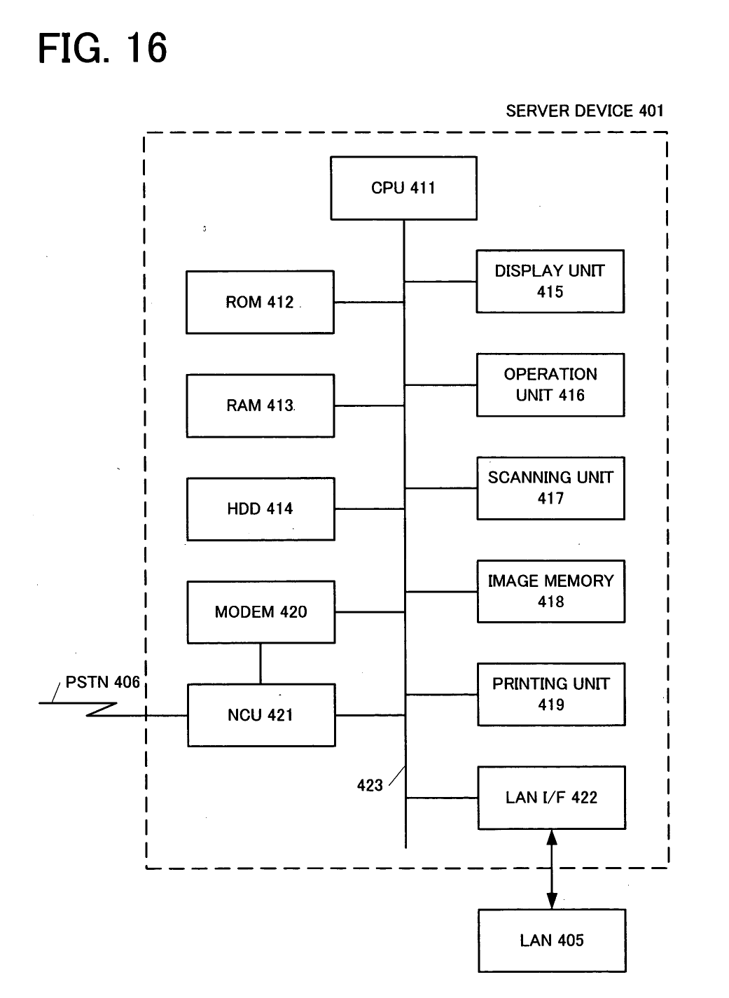

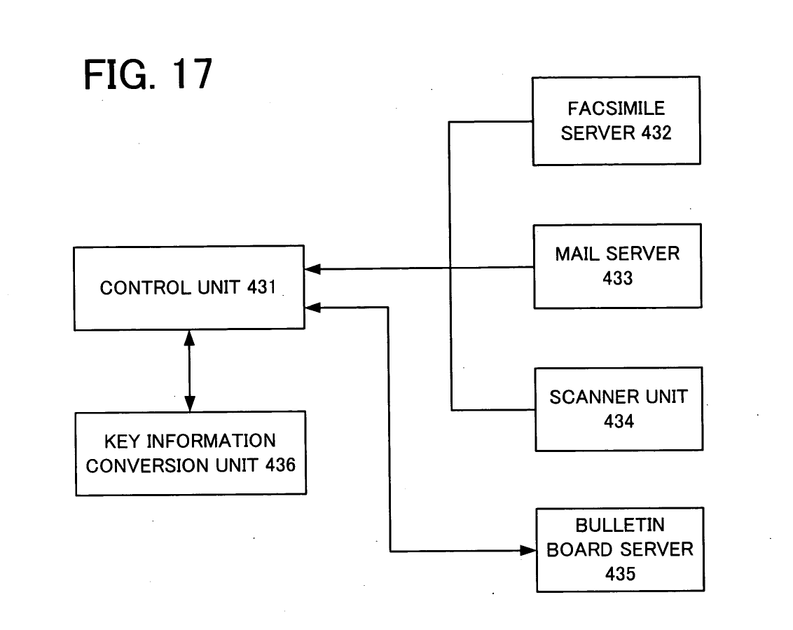

Referring to the drawings, a third embodiment of the present invention will be described. FIG. 15 is a block diagram showing an example of a network configuration of a system including a document management server device of the present invention. FIG. 16 is a block diagram showing a hardware configuration of a server device. FIG. 17 is a functional block diagram showing functions of the server device.

In FIG. 15, reference numeral 401 denotes a server device, 402, 403, 404, . . . denote client PCs, 405 denotes a LAN, 406 denotes a PSTN and 407 denotes the Internet. The server device 401 includes functions of an electronic bulletin board server, a facsimile server, a mail server or the like. The server device 401 is connected to the PSTN 406 and connected to the LAN 405 that is one of communication networks. A plurality of client PCs 402, 403, 404, . . . are connected to the LAN 405 and also to the Internet 407.

Referring to FIG. 16, the hardware configuration of the server device 401 will be described. As shown in FIG. 16, the server device 401 includes a CPU 411, a ROM 412, a RAM 413, a HDD 414, a display unit 415, an operation unit 416, a scanning unit 417, an image memory 418, a printing unit 419, a modem 420, an NCU 421 and a LAN interface 422. Each of the units is connected via a bus 423.

The CPU 411 controls each of the hardware units of the server device 401 via the bus 423. The CPU 411 executes various programs in accordance with programs stored in the ROM 412.

The RAM 413 is formed of a SRAM or the like and stores temporary data that generates when a program is executed. Further, a FLASH MEMORY can be used for the RAM 413. In this case, even when there is a power failure or even when a power source of the server device 401 is shut, stored contents are not lost.

The HDD 414 stores a text file or an image file of a comment registered with an electronic bulletin board server and electronic bulletin board information. In addition, the HDD 414 stores a facsimile image forwarded to a facsimile server.

The display unit 415 is a display device such as a LCD or a CRT display. The display unit 415 displays operational status of the server device 401 and displays an operation screen of various functions.

The operation unit 416 includes various function keys that are necessary for operating the server device 401. Further, by forming the display unit 415 as a touch panel, a part of all of the various keys of the operation unit 416 can be substituted.

The scanning unit 417 scans an original document by a scanner using a CCD or the like and outputs dot image data converted into a binary of black and white.

The image memory 418 is formed of a DRAM or the like and stores image data to be transmitted or received image data.

The printing unit 419 includes an electro-photographic printing device and prints out the received data as hardcopy.

The modem 420 is connected to the bus 423 and includes a function as a faxmodem that can carry out facsimile communication. The modem 420 is connected to the NCU 421 that is also connected to the bus 423.

The NCU 421 is a hardware that closes and releases an analog line. The NCU 421 connects the modem 420 to the PSTN 406 when necessary.

The LAN interface 422 is connected to the LAN 405. The LAN interface 422 receives a signal or data from the LAN 405 and transmits a signal or data to the LAN 405. The LAN interface 422 executes an interface process such as a signal conversion or a protocol conversion.

FIG. 17 is a functional block diagram showing functions of the server device 401. The server device 401 includes a control unit 431, a facsimile server 432, a mail server 433, a scanner unit 434, an electronic bulletin board server 435 and a key information conversion unit 436. Each of the units is formed of the CPU 411, the ROM 412, the RAM 413 and the HDD 414 of FIG. 16. The function of each unit is executed by a software program.

The facsimile server 432 includes a Hyper Text Transfer Protocol (HTTP) server that stores image data received by facsimile in a storage area of a prescribed Uniform Resource Locator (URL). In accordance with respective protocols, the facsimile server 432 can forward the image data received by facsimile to a client PC of a forwarding destination or another facsimile machine connected to the Internet. The facsimile server 423 can receive image data from the client PCs 402, 403, 404, . . . and transmit the image data by facsimile to a transmitting destination designated by the client.

The mail server 433 includes a HTTP server that stores received mail in a storage area of a prescribed URL. The mail server 433 can forward the received mail to a client PC of a forwarding destination or another mail server connected to the Internet in accordance with a corresponding protocol. In addition, the mail server 433 can receive mail from the client PCs 402, 403, 404, . . . and transmit the received mail to a transmitting destination designated by the client.

The scanner unit 434 forwards a scanner image scanned by the scanning unit 417 of FIG. 16 to the control unit 431.

The electronic bulletin board server 435 manages a document including an image received by facsimile, an image scanned by the scanner, an image transmitted from the client PCs 402, 403, 404, an image received by Internet facsimile using electronic mail or an image scanned by the scanning unit. In addition, the electronic bulletin board server 435 generates electronic bulletin board information with the documents as information.

The key information conversion unit 436 stores key information (for example, keyword and category) for management of a document in each of the facsimile server 432, the mail server 433 and the electronic bulletin board server 435, and a rule for automatically converting the key information reciprocally. By referencing the rule and converting the key information when transferring a document between the servers, the transferred document can be managed appropriately at a server that received the transferred document.

As an example of the key information of the document management, the facsimile server 432 and the mail server 433 distinguish a name of the transmitter in accordance with communication information and convert the name of the transmitter into key information that classifies the document. The electronic bulletin board server 435 classifies documents with a category as the key information. These pieces of key information are registered with the key information conversion unit 436.

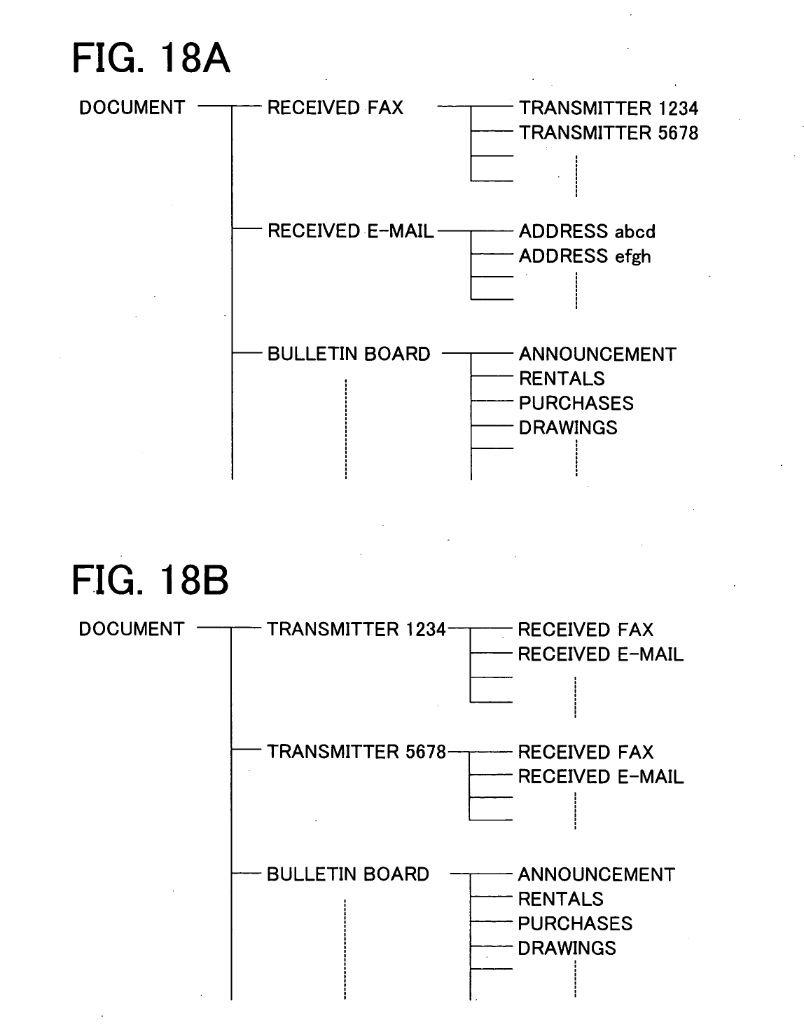

FIGS. 18A and 18B respectively show an example of a classification of a document. In FIG. 18A, as a large classification, a received facsimile, a received mail and a bulletin board are set. As a small classification, a name of a transmitter of the facsimile, a subaddress of the mail and a category of the bulletin board or the like are set. This classification is registered with the key information conversion unit 436 in advance. However, when forwarding a facsimile or a mail received from an unregistered transmitter, the name of this transmitter can be added to the classification.

As shown in FIG. 18B, the name of the transmitter can be set as a large classification, and the received facsimile and the received mail can be set as a small classification.

Meanwhile, as the category of the electronic bulletin board, announcement, rentals, purchases, drawings, patent information, etc. are set. A rule for an automatic conversion between the category of the electronic bulletin board and the key information of the facsimile document and the mail document is set as follows:

facsimile: transmitter 1234 → bulletin board: rentals
transmitter 5678 → components
transmitter 8888 → patent information

The rules for all of the registered classifications are set in the key information conversion unit 436.

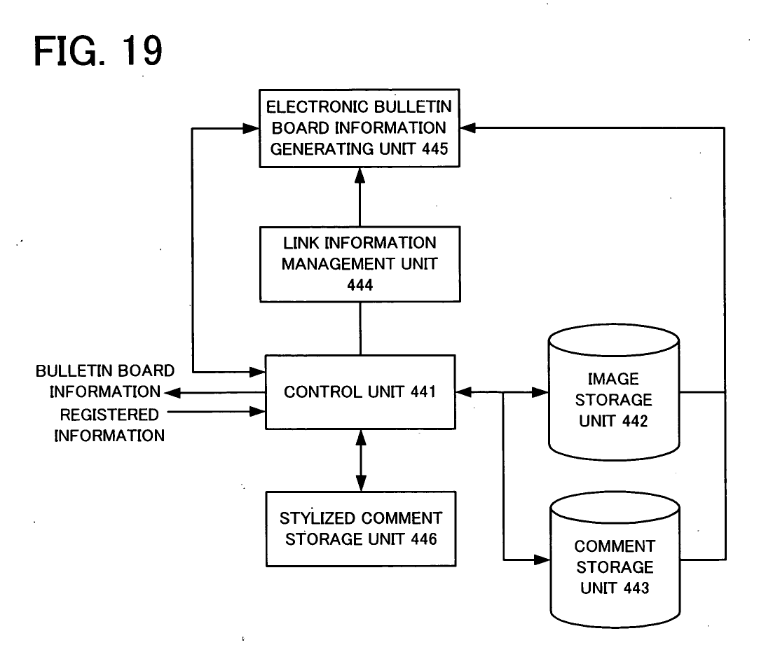

Next, referring to the functional block diagram of the electronic bulletin board server of FIG. 19, a description will be made to the details of the electronic bulletin board server 435. As shown in FIG. 19, the electronic bulletin board server includes a control unit 441, an image storage unit 442, a comment storage unit 443, a link information management unit 444, an electronic bulletin board information generating unit 445 and a stylized comment storage unit 446. Each of the units is also formed of the CPU 411, the ROM 412, the RAM 413 and the HDD 414 of FIG. 16. The function of each of the units is executed by software programs.

When a comment and an image are registered, the control unit 441 provides identification information to the registered image and comment. The image provided with the identification information is stored in the image storage unit 442. The comment provided with the identification information is stored in the comment storage unit 443. In addition, link information of the image and the comment is generated. The generated link information and the identification information of the image and the comment are transmitted to the link information management unit 444.

When a comment or an image is registered newly or when there is a reply of a comment, the control unit 441 instructs the electronic bulletin board information generating unit 445 to generate new electronic bulletin board information. The electronic bulletin board information generated by the electronic bulletin board information generating unit 445 is transmitted to the client PC.

Furthermore, when receiving a forwarded document, the control unit 441 retrieves a comment according to the category of the document from the stylized comment storage unit 446, and stores the comment in the comment storage unit 443.

The image storage unit 442 stores an image file of the image registered with the electronic bulletin board.

The comment storage unit 443 stores a text file consisting of a title and a main text of a newly registered comment or a reply comment.

The link information management unit 444 forms and stores a link of a comment in accordance with the link information of the comment generated by the control unit 441.

The electronic bulletin board information generating unit 445 generates electronic bulletin board information in accordance with the link information from the link information management unit 444 and the information from the image storage unit 442 and the comment storage unit 443. Further, the generated electronic bulletin board information includes information of a title of a comment for each thread, an image icon, a title and a main text of a currently selected comment and an image, in case an image is attached to the comment, and also information of a thumbnail list display of all images included in the selected thread.

The stylized comment storage unit 446 stores simple texts as the fixed document for each category of the posted document. For example, in case of “ANNOUNCEMENT”, a title “ANNOUNCEMENT” and a main text “This is announcement” are stored. In case of “DRAWINGS”, a title “DRAWINGS” and a main text “Please confirm and correct the drawings” are stored. In case of rentals, a title “RENTALS” and a main text “Please handle the rentals” are stored.

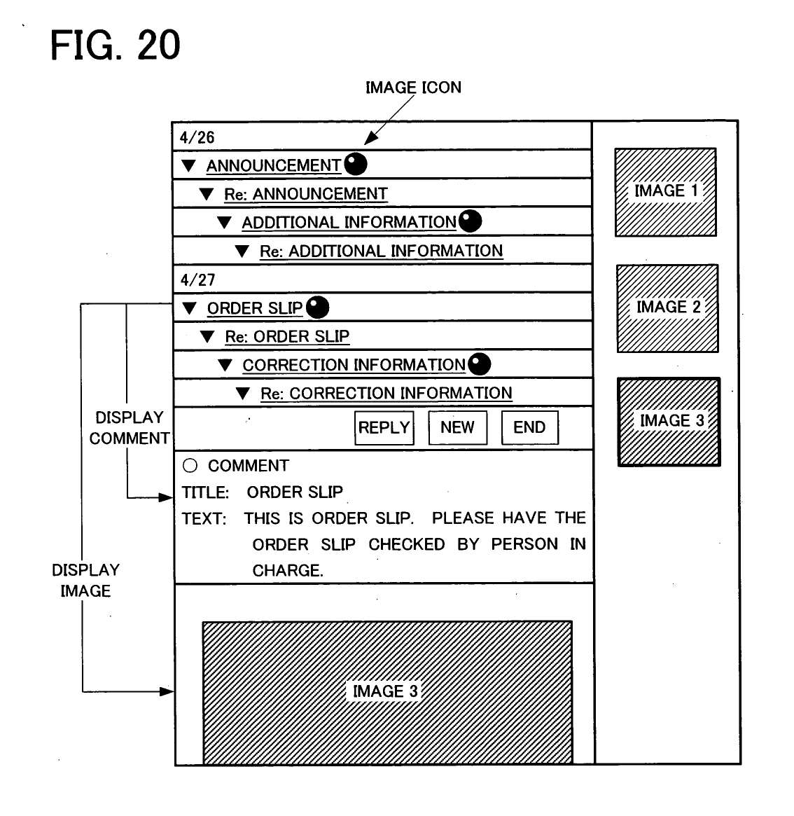

FIG. 20 shows an example of a display screen of the electronic bulletin board. As shown in FIG. 20, in an upper part of the electronic bulletin board, a list of titles of a thread display arranged in an order of the threads is displayed. When a new image is attached to a comment, an image icon is displayed next to the title of that comment. This thread display expresses a parent-child relationship of each comment. When someone replies to a certain comment, the reply comment becomes a child deriving from the original comment.

As shown in the drawing, with respect to a title of a certain comment, a title of a reply comment to that comment is indented. In the same manner, a title of a reply to this comment is further indented. The entire group of comments that derived from one comment by such a relationship of replies or the like is a thread. In the example shown in FIG. 20, two threads are displayed.

Below the title list screen of the thread display, the title and the main text of the currently selected comment and an image, in case an image is attached to the comment, are displayed. In a right side of the electronic bulletin board screen, a list of all images included in the selected thread is displayed as a thumbnail. A focus is placed on an image (in the drawing, an image 3) that is a base of the displayed comment. By clicking one of the images among the thumbnail displayed list, an image and a comment corresponding to the thumbnail display can be referenced.

Next, referring to FIGS. 16, 17, 19, 21 and 22, a description will be made to an operation of the server device 401 as an example of when transferring a document from the facsimile server 432 to the electronic bulletin board server 435.

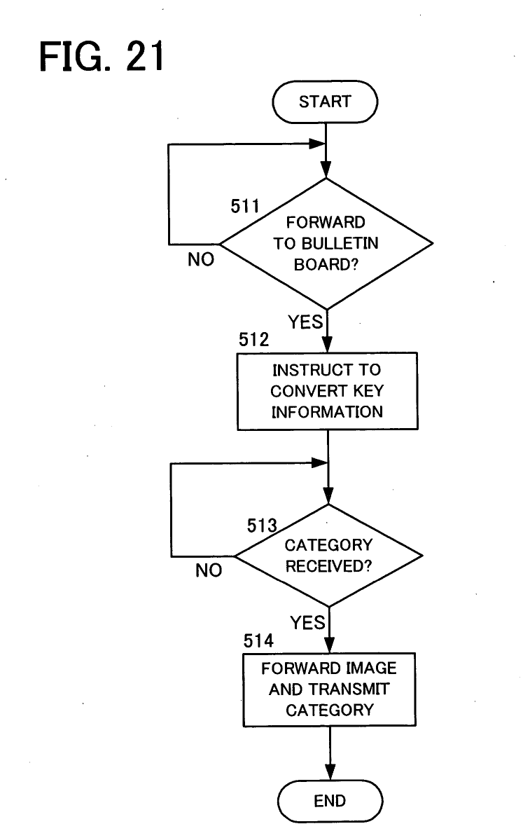

When the user designates a document of the facsimile server 432 from the operation unit 416 of the server device 401 and instructs to forward the document to the electronic bulletin board server 435, as shown in the flowchart of FIG. 21, the control unit 431 determines that there is a request to forward the document to the electronic bulletin board (step 511). The key information (in this case, a transmitter) included in the document to be forwarded is transmitted to the key information conversion unit 436. Then, the control unit 431 instructs a conversion of the key information (step 512).

The key information conversion unit 436 searches the set rule and decides the key information (category) of the electronic bulletin board corresponding to the received key information (transmitter). Then, the key information conversion unit 436 transmits the decided key information to the control unit 431. When the control unit 431 determines that the category has been received from the key information conversion unit 436 (step 513), the control unit 431 transmits the designated image of the facsimile server 432 to the electronic bulletin board server 435 along with the decided category (step 514).

For example, when an image of the “transmitter 1234” is forwarded from the facsimile server 432 to the electronic bulletin board server 435, the category “RENTALS” is decided by the key information conversion unit 436 based on the above-described rule. Then, the image is transmitted to the electronic bulletin board server 435 along with the decided category.

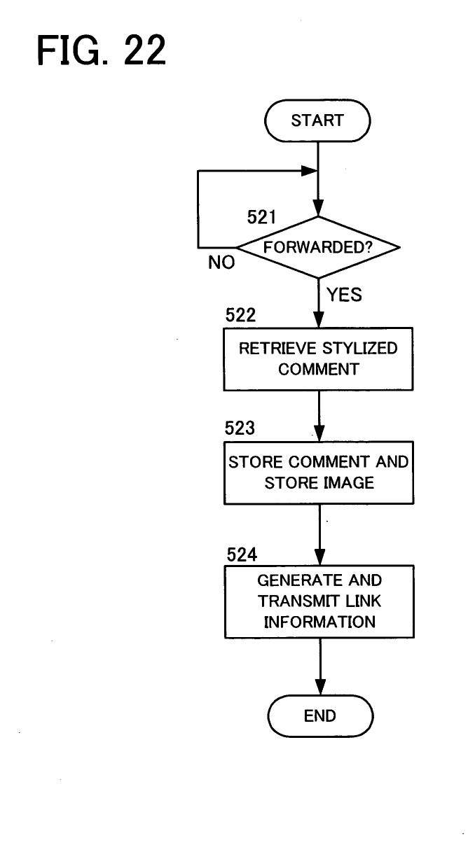

As described above, the control unit 431 of the server device 401 forwards the designated image of the facsimile server 432 and the conversion key (category “RENTALS”) to the electronic bulletin board server 435. As shown in the flowchart of FIG. 22, the control unit 441 of the electronic bulletin board server 435 determines whether or not an image has been forwarded (step 521). In accordance with the category of the forwarded image, the control unit 441 retrieves from the stylized comment storage unit 446, the stylized comment of the “RENTALS”, i.e., the title “RENTALS” and the main text “Please handle the rentals” (step 522).

Next, the control unit 441 provides identification information to the stylized comment. In addition, the control unit 441 stores the stylized comment provided with the identification information in the comment storage unit 443. The control unit 441 provides identification information to the forwarded image. Then, the control unit 441 stores the image provided with the identification information in the image storage unit 442 (step 523).

Subsequently, the control unit 441 newly generates link information of the image and the comment, and transmits the link information and the identification information of the image and the comment to the link information management unit 444 (step 524). As described above, when an image is forwarded from the facsimile server to the electronic bulletin board server, the category, which is the key information of the electronic bulletin board, is decided automatically, and the fixed text of the category is formed as a comment. Therefore, just by instructing to forward an image, the user can easily forward an image from the facsimile server to the electronic bulletin board server.

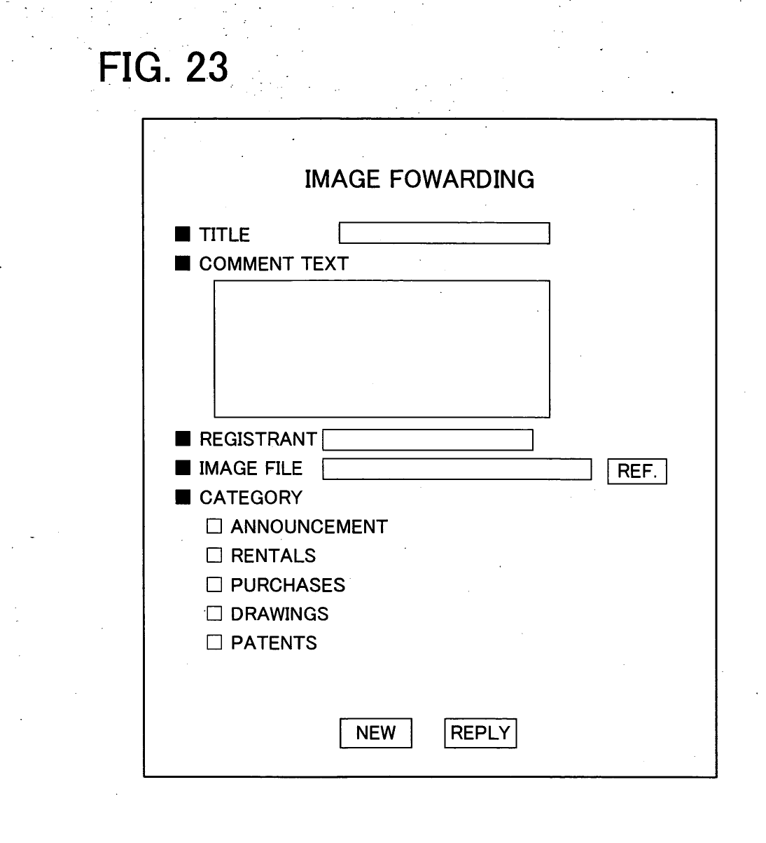

In the above-described embodiment, the category is decided automatically and the comment is generated automatically. However, the user can select the category, enter the comment or select whether to make a new registration or to send a reply. Referring to FIGS. 23, 24 and 25, a description will be made to a case in which the user makes an instruction when forwarding an image.

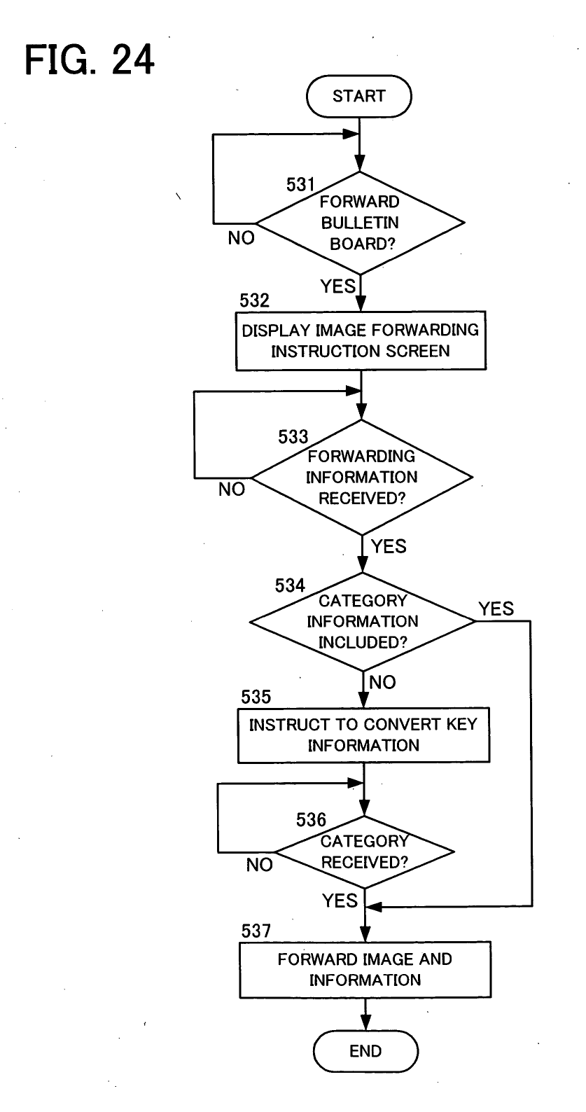

When the user instructs forwarding of an image of the facsimile server 432 to the electronic bulletin board server 435 from the operation unit 416 of the server device 401, as shown in the flowchart of FIG. 24, the control unit 431 determines that there has been a forwarding instruction (step 531). Then, the control unit 431 displays the image forwarding instruction screen of FIG. 23 on the display unit 415 of the server device 401.

As shown in FIG. 23, the image forwarding instruction screen includes a title input section for inputting a title of a comment, a main text input section, a registrant input section for inputting a name of a registrant, a file name input section for inputting a file name of an image to be forwarded and a category list of the electronic bulletin board stored in the key information conversion unit 436. In a lower part of the instruction screen, a “NEW” icon for making new registration to the electronic bulletin board and a “REPLY” icon for sending a reply to the electronic bulletin board are displayed.

The user inputs a title and a main text of the comment and the name of the registrant. By clicking “REF.” at the image file input section, a list of files is displayed. Then, by selecting a corresponding image file of the facsimile server from the list, an image is selected.

After designating a category by clicking a white box (“□”) in front of the category selected from the category list, when the “NEW” icon is clicked, these pieces of information are transmitted to the control unit 431.

Meanwhile, when the user clicks the “REPLY” icon, the control unit 431 retrieves comment information from the electronic bulletin board server 435. In addition, a title list that is like the thread display of the titles of the comments in the upper part of FIG. 20 is displayed on the display unit 415. When the user selects either one of the comments, the above information is transmitted to the control unit 431 as a reply to the selected comment.

When such a piece of information is transmitted to the control unit 431, the control unit 431 determines that the forwarding information has been received (step 533). Then, the control unit 431 determines whether or not category information is included in the forwarding information (step 534). When category information is included in the forwarding information, the forwarding information and the designated image of the facsimile server 432 are forwarded to the electronic bulletin board server 435 (step 537).

Meanwhile, when category information is not included in the forwarding information, the key information (transmitter) included in the image to be forwarded is transmitted to the key information conversion unit 436, and the conversion of the key information is instructed (step 535). Consequently, the key information conversion unit 436 searches the set rule and decides the key information (category) of the electronic bulletin board corresponding to the transmitted key information (transmitter). Then, the decided key information is transmitted to the control unit 431. When the control unit 431 determines that the category has been received from the key information conversion unit 436 (step 536), the control unit 431 forwards to the electronic bulletin board server 435, the designated image of the facsimile server 432, the decided category and other forwarding information (step 537).

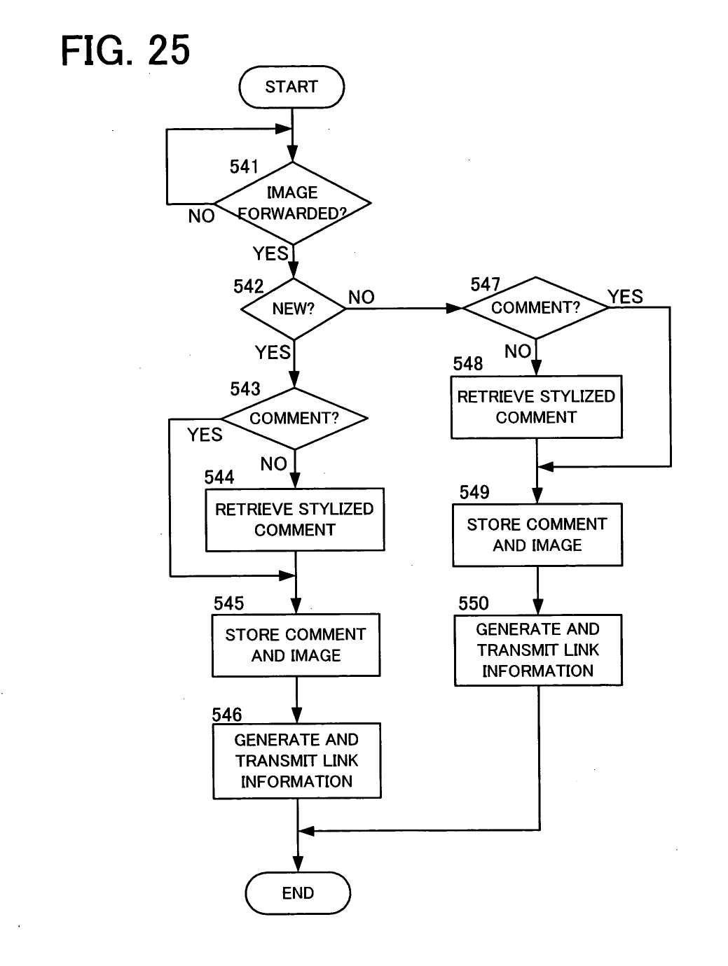

Next, referring to the flowchart of FIG. 25, a description will be made to a process carried out by the electronic bulletin board server 435 when the above-mentioned information is forwarded to the electronic bulletin board server 435. As described above, when the image and the forwarding information are forwarded to the electronic bulletin board server 435, the control unit 441 of the electronic bulletin board server 435 determines whether or not an image has been forwarded (step 541). First, the control unit 441 determines whether “NEW REGISTER” or “REPLY” is selected (step 542). In case of “NEW REGISTER”, the control unit 441 determines whether or not there is a comment (step 543). When there is no comment, in accordance with the category of the forwarded image, the control unit 441 retrieves a stylized comment of the category from the stylized comment storage unit 446 (step 544).

Next, the control unit 441 provides identification information to the stylized comment or the comment entered by the user. The comment provided with the identification information is stored in the comment storage unit 443. In addition, identification information is provided to the forwarded image. The image provided with the identification information is stored in the image storage unit 442 (step 545). Then, the control unit 441 newly generates link information of the image and the comment, and transmits the generated link information and the identification information of the image and the comment to the link information management unit 444 (step 536). Accordingly, the link is corrected and stored by the link information management unit 444.

Meanwhile, at step 542, when it is determined that “REPLY” is selected, a determination is made as to whether or not there is a comment (step 547). When there is no comment, in accordance with the category of the forwarded image, the stylized comment of the category is retrieved from the stylized comment storage unit 446 (step 548).

Next, the control unit 441 provides identification information to the stylized comment or the comment entered by the user. The comment provided with the identification information is stored in the comment storage unit 443. In addition, identification information is provided to the forwarded image and the image provided with the identification information is stored in the image storage unit 442 (step 549).

Then, the control unit 441 generates link information that links the comment to the original comment, and transmits the link information to the link information management unit 444 along with the identification information of the image and the comment (step 550).

As described above, when forwarding an image from the facsimile server to the electronic bulletin board server, the user can select any category and select whether to make a new registration or to send a reply.

Furthermore, when the user does not select a category, the category is decided by the key information conversion. In case the user does not provide a comment, the stylized comment of the category selected by the user is generated as the comment. Therefore, the image can be forwarded by skipping these processes.

Further, in the above-described embodiment, the document forwarding method of the present invention is described with reference to an example in which the image is forwarded from the facsimile server in the document management server device to the electronic bulletin board server. However, the present invention is not limited to this example, and the document forwarding method of the present invention can be used for forwarding a document between various applications.

In the above-described embodiment, the present invention is applied to the document management server device having the facsimile receiving function. However, the present invention can also be applied to a document management server device which does not include a facsimile receiving function by forwarding a facsimile image from a facsimile receiver to a facsimile server.

In the above-described embodiment, a comment consisting of a title and a main text is stored in the stylized comment storage unit. However, when the user can recognize the content just from the title, it is not necessarily required to store the main text. Furthermore, the categories of the electronic bulletin board are not limited to the categories described in the embodiment, and various categories can be adopted. In addition, the key information of the facsimile server and the mail server is not limited to the name of the transmitter, and a telephone number or a category can be adopted for the key information.

What is claimed is:

1. A server device having an electronic bulletin board function comprising:
an image storage unit that stores image data;
a comment storage unit that stores text data as a comment relating to the image data;
an automatic comment generating unit that generates a comment indicating a reception of a reply of edited image data for the image data stored in the image storage unit and stores the comment in the comment storage unit when receiving the reply of the edited image data for the image data stored in the image storage unit; and
an electronic bulletin board generating unit that generates electronic bulletin board information including the generated comment and the edited image data or shortcut information to the comment and the image data.

2. The server device having the electronic bulletin board function according to claim 1, further comprising:
an image data version information management unit that manages a version of the image data stored in the image storage unit.

3. The server device having the electronic bulletin board function according to claim 1, further comprising:
a differential image information storage unit that stores edited information as differential image information for the image data.

4. A server device having an electronic bulletin board function comprising:
an image storage unit that stores image data;
a comment storage unit that stores text data as a comment relating to the image data;
an automatic comment generating unit that generates a comment indicating that image data is registered newly when image data is registered newly in the image storage unit; and
an electronic bulletin board generating unit that generates electronic bulletin board information including the generated comment and the newly registered image data or shortcut information to the comment and the image data.

5. The server device having the electronic bulletin board function according to claim 4, further comprising:
a facsimile receiving unit that receives image data;
wherein the received image data is newly registered.

6. A server device having an electronic bulletin board function comprising:
an image storage unit that stores image data;
a comment storage unit that stores text data as a comment relating to the image data;
an electronic bulletin board generating unit that generates electronic bulletin board information in accordance with the image data and the text data; and
a control unit that displays on the electronic bulletin board generating unit, a thread display of comments and a list display of image data included in a selected thread.

7. The server device having the electronic bulletin board function according to claim 6, wherein the control unit generates electronic bulletin board information focused on original image data of the selected thread among the list-displayed image data.

8. A server device having an electronic bulletin board function comprising:
a comment storage unit that stores text data as a comment by a unit of threads;
an image storage unit that stores image data attached to the comment; and
a file composing unit that selects image data or text data attached to a specific thread or comment and composes the selected image data or text data as a file.

9. The server device having the electronic bulletin board function according to claim 8, wherein the file composing unit converts text data by a designated font and composes the text data.

10. The server device having the electronic bulletin board function according to claim 8, wherein the file composed by composing the image data or the text data attached to the specific thread or comment by the file composing unit is displayed in a thumbnail list on an electronic bulletin board.

11. The server device having the electronic bulletin board function according to claim 8, wherein the file composing unit generates Hyper Text Markup Language (HTML) data of a thread index by a unit of threads, HTML data of text data and image data, and packages all of the data into one file.

12. A document forwarding method of a document management server device comprising the steps of:
retrieving a document of an application of a forwarder in the document management server device;
converting key information of the application of the forwarder of the document into key information of an application of a forwarding destination; and
forwarding the document including the converted key information as a document of the application of the forwarding destination.

13. A document management server device having an electronic bulletin board function comprising:
an electronic bulletin board unit that handles an image file and a text file as a posting document;
a facsimile unit that receives a document; and
a key information conversion unit that stores key information of a document and reciprocally converts each key information;
wherein when the document received by the facsimile unit is forwarded to the electronic bulletin board unit, the key information conversion unit converts key information of the received document into key information of an electronic bulletin board in accordance with communication information.

14. A document management server device having an electronic bulletin board function comprising:
an image storage unit that stores image data;
a comment storage unit that stores text data as a comment relating to the image data;
an electronic bulletin board unit that handles the image data and the text data as a posting document;
a stylized comment storage unit that stores a stylized comment corresponding to a category of an electronic bulletin board;
a facsimile receiving unit that receives image data; and
a control unit that retrieves a stylized comment from the stylized comment storage unit according to the category of the image data when the image data is forwarded to the image storage unit, and stores the retrieved comment in the comment storage unit.

15. A document management server device having an electronic bulletin board function comprising:
an image storage unit that stores image data;
a comment storage unit that stores text data as a comment corresponding to the image data;
an electronic bulletin board unit that handles the image data and the text data as a posting document;
a category storage unit that stores categories of an electronic bulletin board; and
a selecting unit that designates one of the categories stored in the category storage unit when forwarding the image data to the electronic bulletin board unit, and selects whether to make a new registration or to send a reply to the electronic bulletin board.
